(19) United States
(12) Patent Application Publication
(10) Pub. No.: US 2015/0024728 A1
(43) Pub. Date: Jan. 22, 2015

(54) MOBILE TERMINAL AND CONTROLLING METHOD THEREOF

(71) Applicant: Yoonsuk JANG, Seoul (KR)

(72) Inventor: Yoonsuk JANG, Seoul (KR)

(73) Assignee: LG ELECTRONICS INC., Seoul (KR)

(21) Appl. No.: 14/310,693

(22) Filed: Jun. 20, 2014

(30) Foreign Application Priority Data
Jul. 16, 2013 (KR) 10-2013-0083366

(51) Int. Cl. H04M 1/725

(52) U.S. Cl. CPC H04M 1/72519
USPC 455/418

(57) ABSTRACT

A mobile terminal and controlling method thereof are disclosed. The present disclosure includes a transparent display unit having a front side and a rear side, the transparent display unit configured to display information on each of the front side and the rear side, and a controller configured to determine which one of the front side and the rear side faces toward a user based on at least one state of the mobile terminal and to control the information to be displayed on the transparent display unit according to a result of the determination. Accordingly, an information display of a transparent display unit is controlled depending on a result from determining whether one of front and rear sides of the transparent display unit faces toward a user based on at least one state of the mobile terminal.

### CROSS-REFERENCE TO RELATED APPLICATIONS

Pursuant to 35 U.S.C. §119(a), this application claims the benefit of earlier filing date and right of priority to Korean Patent Application No. 10-2013-0083366 filed on Jul. 16, 2013, the contents of which are hereby incorporated by reference herein in their entirety.

### BACKGROUND

1. Field

The present disclosure relates to a mobile terminal, and more particularly, to a mobile terminal and a method of controlling the mobile terminal.

2. Background

A mobile terminal is a device that can be configured to perform various functions, such as data and voice communications, capturing still images and video via a camera, recording audio, playing music files and outputting music via a speaker system, and displaying images and video on a display. Some terminals include additional functionality to support game playing, while other terminals are also configured as multimedia players. More recently, mobile terminals have been configured to receive broadcast and multicast signals to permit viewing of content, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

Recently, as a smartphone market is increasingly expanding, the number of smartphone users is rapidly increasing. And, smartphones equipped with various functions come closer to daily lives of smartphone users.

Specifically, as a display unit of a smartphone tends to include a transparent display capable of displaying information on its front and rear sides, a user of the smartphone is able to read the information displayed on the front and rear sides of the smartphone. However, when a user reads information displayed on the rear side of a smartphone, it causes a problem that the information is reversely displayed on the rear side.

In particular, when a user holds a smartphone in a manner that a front side of the smartphone faces toward the user, information displayed on the front side of the smartphone is displayed in a correct direction. Yet, if a user holds a smartphone in a manner that a rear side of the smartphone faces toward the user, it causes a problem that information displayed on the rear side of the smartphone is reversely displayed.

### SUMMARY OF THE INVENTION

Accordingly, embodiments of the present disclosure are directed to a mobile terminal and controlling method thereof that substantially obviate one or more problems due to limitations and disadvantages of the related art.

An object of the present disclosure is to provide a mobile terminal and controlling method thereof, by which an information display of a transparent display unit is controlled depending on a result from determining whether one of front and rear sides of the transparent display unit faces toward a user based on at least one state of the mobile terminal.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a mobile terminal according to one embodiment of the present disclosure may include a transparent display unit having a front side and a rear side, the transparent display unit configured to display information on each of the front side and the rear side, and a controller configured to determine which one of the front side and the rear side faces toward a user based on at least one state of the mobile terminal and to control the information to be displayed on the transparent display unit according to a result of the determination.

In another aspect of the present disclosure, a method of controlling a mobile terminal, which includes a transparent display unit having a front side and a rear side to display information on each of the front side and the rear side, according to the present disclosure may include the steps of recognizing at least one state of the mobile terminal, determining which one of the front side and the rear side faces toward a user based on the recognized at least one state, and controlling the information to be displayed on the transparent display unit according to a result of the determination.

Effects obtainable from the present disclosure may be non-limited by the above mentioned effect. And, other unmentioned effects can be clearly understood from the following description by those having ordinary skill in the technical field to which the present disclosure pertains.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. The above and other aspects, features, and advantages of the present disclosure will become more apparent upon consideration of the following description of preferred embodiments, taken in conjunction with the accompanying drawing figures. In the drawings:

FIG. 1 illustrates a block diagram of a mobile terminal in accordance with one embodiment of the present disclosure;

FIG. 2A is a front perspective view of the mobile terminal in accordance with one embodiment of the present disclosure;

FIG. 2B is a rear perspective view of the mobile terminal in accordance with one embodiment of the present disclosure;

FIGS. 3 to 5 are perspective diagrams of front and rear side of a mobile terminal having a transparent display unit according to the present disclosure;

FIG. 6 is a flowchart for a method of controlling an information display in a mobile terminal according to the present disclosure; and

FIGS. 7 to 24 are diagrams to describe a method of controlling an information display in a mobile terminal according to the present disclosure.

### DETAILED DESCRIPTION

In the following detailed description, reference is made to the accompanying drawing figures which form a part hereof, and which show by way of illustration specific embodiments of the disclosure. It is to be understood by those of ordinary skill in this technological field that other embodiments may be utilized, and structural, electrical, as well as procedural changes may be made without departing from the scope of the present disclosure. Wherever possible, the same reference numbers will be used throughout the drawings to refer to the same or similar parts.

The terms “module,” “unit,” and “part” are used herein with respect to various elements only to facilitate disclosure of the disclosure. Therefore, the terms “module,” “unit,” and “part” are used interchangeably herein.

The present disclosure can be applied to various types of terminals. For example, the terminals can include mobile terminals as well as stationary terminals, such as mobile phones, user equipments, smart phones, digital televisions (DTVs), computers, digital broadcast terminals, personal digital assistants, portable multimedia players (PMP) and navigators.

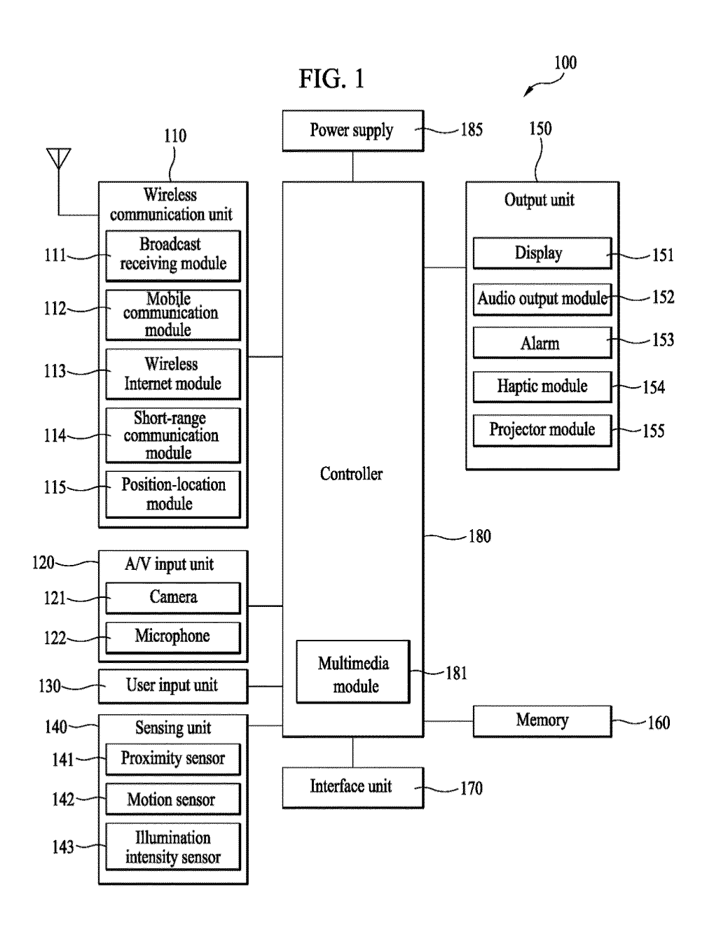

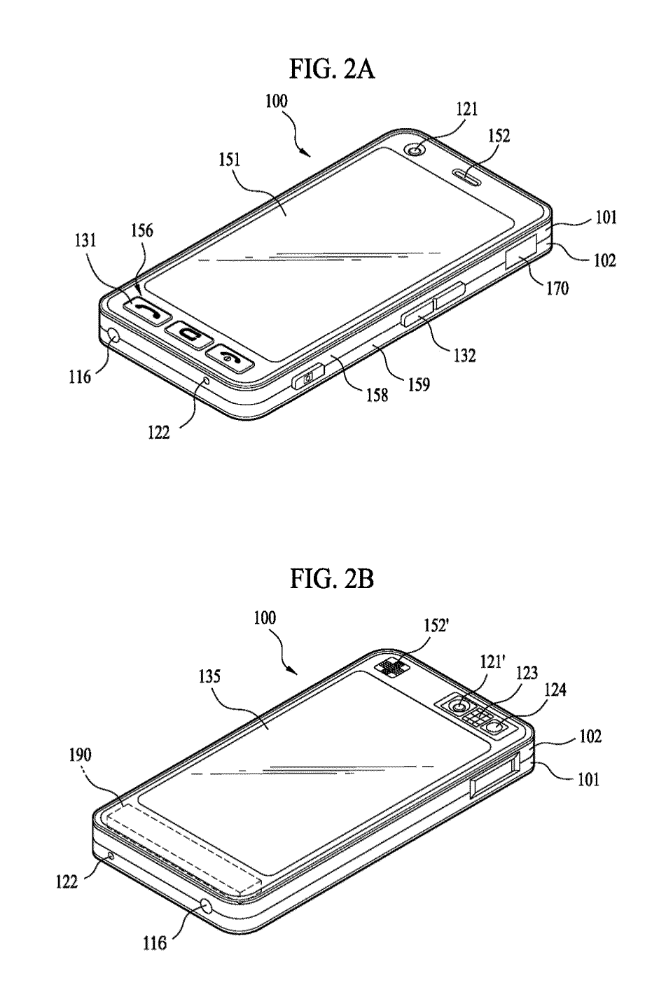

For ease of description, the present disclosure will be described with respect to a mobile terminal 100 shown in FIGS. 1 through 2B. However, it should be understood that the present disclosure can also be applied to other types of terminals.

FIG. 1 illustrates an exemplary block diagram of the mobile terminal 100 in accordance with one embodiment of the present disclosure. It should be understood that embodiments, configurations and arrangements other than that depicted in FIG. 1 can be used without departing from the spirit and scope of the disclosure. As shown in FIG. 1, the mobile terminal 100 includes a wireless communication unit 110, an audio/video (AV) input unit 120, a user input unit 130, a sensing unit 140, an output unit 150, a memory 160, an interface unit 170, a controller 180, and a power supply unit 190. It should be understood that the mobile terminal 100 may include additional or fewer components than those shown in FIG. 1.

The wireless communication unit 110 can include one or more components for allowing wireless communication between the mobile terminal 100 and a wireless communication system or network within which the mobile terminal 100 is located. For example, the wireless communication unit 110 can include a broadcast receiving module 111, a mobile communication module 112, a wireless Internet module 113, a short-range communication module 114, and a position-location module 115.

The broadcast receiving module 111 receives a broadcast signal and/or broadcast related information from an external broadcast management server via a broadcast channel. In one embodiment, the mobile terminal 100 can be configured to include two or more broadcast receiving modules 111 to enable simultaneous reception of two or more broadcast channels or to facilitate switching of broadcast channels.

The broadcast channel can include a satellite channel and a terrestrial channel. The broadcast management server can be a server that generates and transmits a broadcast signal and/or broadcast related information, or a server that receives a previously-generated broadcasting signal and/or previously-generated broadcasting-related information and transmits the previously-generated broadcast signal and/or previously-generated broadcasting-related information to the mobile terminal 100.

For example, the broadcast signal can be implemented as a TV broadcast signal, a radio broadcast signal, a data broadcast signal, and various other types of signals. In one embodiment, the broadcast signal can include a combination of the broadcast signal and a TV broadcast signal or a combination of the broadcast signal and a radio broadcast signal.

The broadcast-related information can include broadcast channel information, broadcast program information, or broadcast service provider information. The broadcast-related information can be provided to the mobile terminal 100 through a mobile communication network. In such a case, the broadcast-related information can be received by the mobile communication module 112.

The broadcast-related information can be implemented in various forms. For example, the broadcast-related information can have the form of an electronic program guide (EPG) of the digital multimedia broadcasting (DMB) standard, or an electronic service guide (ESG) of the digital video broadcast-handheld (DVB-H) standard.

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), Convergence of Broadcasting and Mobile Service (DVB-CBMS), Open Mobile Alliance-BroadCAST (OMA-BCAST), China Multimedia Mobile Broadcasting (CMMB), Mobile Broadcasting Business Management System (MBBMS), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast receiving module 111 can be configured to receive signals from broadcasting systems providing broadcasting signals other than the above-described digital broadcasting systems. The broadcast signal and/or broadcast-related information received via the broadcast receiving module 111 can be stored in a storage medium, such as the memory 160.

The mobile communication module 112 can transmit and/or receive wireless signals to and/or from at least one network entity, such as a base station, an external terminal, or a server. For example, such wireless signals can include audio, video, and data according to a transmission and reception of text/multimedia messages.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 can be a module for supporting relatively short-range communications. For example, the short-range communication module 114 can be configured to communicate using short range communication technology, such as, radio frequency identification (RFID), Infrared Data Association (IrDA), or Ultra-wideband (UWB), as well as networking technologies, such as Bluetooth™ or ZigBee™

The position-location module 115 identifies or otherwise obtains the location of the mobile terminal 100. In one embodiment, the position-location module 115 can include a global positioning system (GPS) module.

The A/V input unit 120 can be used to input an audio signal or a video signal, and can include a camera 121 and a microphone 122. For example, the camera 121 can have a digital zoom feature and can process image frames of still images or video obtained by an image sensor of the camera 121 in a video call mode or a photographing mode. The processed image frames can be displayed on a display unit 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 can receive an external audio signal while operating in a particular mode, such as a phone call mode, a recording mode or a voice recognition mode, and can process the received audio signal into electrical audio data. The audio data can then be converted into a form that can be transmitted to a mobile communication base station through the mobile communication module 112 in the call mode. The microphone 122 can apply various noise removal or noise canceling algorithms for removing or reducing noise generated when the external audio signal is received.

Moreover, according to the present disclosure, the microphone 122 can receive an input of an audio for determining whether one of front and rear sides of the transparent display unit 151 faces toward a user. In this case, the microphone 122 can be provided to each of the front and rear sides of the mobile terminal 122.

The user input unit 130 generates input data responsive to user manipulation of an associated input device or devices. Examples of such devices include a button 136 provided to front/rear/lateral side of the mobile terminal 100 and a touch sensor (constant pressure/electrostatic) 137 and may further include a key pad, a dome switch, a jog wheel, a jog switch and the like [not shown in the drawing].

The sensing unit 140 detects a current state (e.g., an open/closed state of the mobile terminal 100, a location of the mobile terminal 100, a presence or non-presence of a user's direct contact, a presence or non-presence of a user's proximity contact, a compass direction of the mobile terminal 100, an acceleration/deceleration of the mobile terminal 100, a motion of the mobile terminal 100, a surrounding illumination of the mobile terminal 100, an illumination in front of the mobile terminal 100, etc.) of the mobile terminal 100 and then generates a sensing signal for controlling an operation of the mobile terminal 100. Moreover, the sensing unit 140 can sense whether a power is supplied by the power supply unit 190, whether an external device is connected to the interface unit 170, etc. And, the sensing unit 140 may include a proximity sensor 141, a motion sensor 142 and an illumination sensor 143.

The proximity sensor 141 shall be described in association with a touchscreen of a transparent display unit type according to the present disclosure later.

The motion sensor 142 includes a gyroscope sensor, an acceleration sensor, a geomagnetic sensor and the like. The motion sensor 142 senses various motions performed on the mobile terminal 100, an acceleration/deceleration of the mobile terminal 100 and a gravity direction working on the mobile terminal 100 and then outputs the sensed results to the controller 180.

The illumination sensor 143 is arranged on a front or rear side of the mobile terminal 100 or may be arranged on each of the front and rear sides of the mobile terminal 100. The illumination sensor 143 senses an illumination around the mobile terminal 100 or an illumination in front of the mobile terminal 100 and then outputs the sensed illumination to the controller 180.

The output unit 150 can generate visual, auditory and/or tactile outputs and can include the display unit 151, an audio output module 152, an alarm unit 153, a haptic module 154, and a projector module 155. The display unit 151 can be configured to display information processed by the mobile terminal 100.

For example, when the mobile terminal 100 is in a call mode, the display unit 151 can display a user interface (UI) or a graphic user interface (GUI) for placing, conducting, and terminating a call. For example, when the mobile terminal 100 is in the video call mode or the photographing mode, the display unit 151 can additionally or alternatively display images which are associated with such modes, the UI or the GUI.

The display unit 151 can be implemented using display technologies including, for example, a liquid crystal display (LCD), a thin film transistor-liquid crystal display (TFT-LCD), an organic light-emitting diode display (OLED), a flexible display and a three-dimensional display. The mobile terminal 100 can be configured to include more than one display unit 151 according to the configuration of the mobile terminal 100.

For example, the mobile terminal 100 can include a number of display units 151 that are arranged on a single face of the mobile terminal 100, and can be spaced apart from one another or integrated in one body. The number of display units 151 can also be arranged on different sides of the mobile terminal 100.

In one embodiment, the display used in the display unit 151 can be of a transparent type or a light transmittive type, such that the display unit 151 is implemented as a transparent display. For example, the transparent display can include a transparent OLED (TOLED) display. The rear structure of the display unit 151 can also be of a light transmittive type. Accordingly, a user may see an object located behind the body of the mobile terminal 100 through the transparent area of the body of the mobile terminal 100 that is occupied by the display unit 151.

When the display unit 151 and a sensor for sensing a user touch (hereinafter referred to as a “touch sensor”) are configured as a layered structure to form a touch screen, the display unit 151 can be used as an input device in addition to an output device. For example, the touch sensor can be in the form of a touch film, a touch sheet, or a touch pad.

The touch sensor can convert a variation in pressure applied to a specific portion of the display unit 151 or a variation in capacitance generated at a specific portion of the display unit 151 into an electric input signal. The touch sensor can sense pressure resulting from a touch, as well as the position and area of the touch.

When the user applies a touch input to the touch sensor, a signal corresponding to the touch input can be transmitted to a touch controller (not shown). The touch controller can process the signal and transmit data corresponding to the processed signal to the controller 180. The controller 180 can then use the data to detect a touched portion of the display unit 151.

Meanwhile, as mentioned in the foregoing description, if a mutual layer structure is configured with a touch panel and the information displayed front side of the display unit 151 to form a touchscreen, the display unit 151 can be used as an input device for inputting information by a user's touch as well as an output device.

In this case, according to the present disclosure, the display unit 151 is a transparent display unit type. 1st and 2nd touch panels for detecting user's touches are provided to front and rear sides of the transparent display unit 151, respectively. In particular, in case that the 1st touch panel is provided to the front side of the transparent display unit 151, this structure can be named a front touchscreen. In case that the 2nd touch panel is provided to the rear side of the transparent display unit 151, this structure can be named a rear touchscreen.

The proximity sensor 141 can be provided inside the mobile terminal 100, in the vicinity of at least one of the front and rear sides of the transparent display unit 151, or in the vicinity of one of the front and rear sides of the transparent display unit 151. The proximity sensor 141 means a sensor that detects an object approaching the front or rear side of the transparent display unit 151 or a presence or non-presence of an object existing nearby the front or rear sides of the transparent display unit 151 using an electromagnetic field force or infrared rays without a mechanical contact. Durability and utilization of the proximity sensor 141 are better than those of a contact sensor.

The proximity sensor 141 can include a transmittive photo-electric sensor, a direct reflection photo-electric sensor, a mirror reflection photo-electric sensor, a radio frequency oscillation proximity sensor, an electrostatic capacity proximity sensor, a magnetic proximity sensor, and/or an infrared proximity sensor. In one embodiment, the touch screen can include an electrostatic capacity proximity sensor, such that a proximity of a pointer can be detected through a variation in an electric field according to the proximity of the pointer. Accordingly, the touch screen or touch sensor can be classified as the proximity sensor 141.

In case that the touch panels provided to the transparent display unit 151 are electrostatic, they are configured to detect proximity of the pointer using a change of an electromagnetic field attributed to the approach of the pointer.

For purposes of clarity, an action of the pointer approaching the touch screen and being recognized without actually contacting the touch screen will be herein referred to as a “proximity touch,” while an action of bringing the pointer into contact with the touch screen will be herein referred to as a “contact touch.” A proximity touch position of the pointer on the touch screen can correspond to a position on the touch screen from which the pointer is situated perpendicularly with respect to the touch screen.

Via the proximity sensor 141, a proximity touch and a proximity touch pattern, such as a proximity touch distance, a proximity touch duration, a proximity touch position, or a proximity touch movement state can be detected. For example, information corresponding to the detected proximity touch action and proximity touch pattern can be displayed on the touch screen.

The audio output module 152 can output audio data received from the wireless communication unit 110, or stored in the memory 160, in a call receiving mode, a call placing mode, a recording mode, a voice recognition mode, or a broadcast receiving mode. The audio output module 152 can also provide audio signals related to particular functions performed by the mobile terminal 100, such as a call received or a message received. For example, the audio output module 152 can include a speaker, a buzzer, or other audio output device. According to the present disclosure, the audio output module 152 can be provided to each of the front and rear sides of the mobile terminal 100.

The alarm unit 153 can output a signal for indicating the occurrence of an event of the mobile terminal 100, such as a call received event, a message received event and a touch input received event, using a vibration as well as video or audio signals. The video or audio signals can also be output via the display unit 151 or the audio output module 152. Therefore, in various embodiments, the display unit 151 or the audio output module 152 can be considered as a part of the alarm unit 153.

The haptic module 154 can generate various tactile effects that can be physically sensed by the user. For example, a tactile effect generated by the haptic module 154 can include vibration. The intensity and/or pattern of the vibration generated by the haptic module 154 can be controlled. For example, different vibrations can be combined and provided or sequentially provided.

The haptic module 154 can generate a variety of tactile effects in addition to a vibration. Such tactile effects include an effect caused by an arrangement of vertically moving pins that are in contact with the skin of the user; an effect caused by a force of air passing through an injection hole or a suction of air through a suction hole; an effect caused by skimming over the user's skin; an effect caused by contact with an electrode; an effect caused by an electrostatic force; and an effect caused by the application of cold and warm temperatures using an endothermic or exothermic device.

For example, the haptic module 154 can enable a user to sense the tactile effects through a muscle sense of the user's finger or arm, as well as to transfer the tactile effect through direct contact. Optionally, the mobile terminal 100 can include at least two haptic modules 154 according to the configuration of the mobile terminal 100.

The projector module 155 is an element for performing an image projection function of the mobile terminal 100. In one embodiment, the projector module 155 can be configured to display an image identical to or partially different from an image displayed by the display unit 151 on an external screen or wall according to a control signal of the controller 180.

For example, the projector module 155 can include a light source (not shown), such as a laser, that generates adequate light for external projection of an image, means for producing the image (not shown) to be projected via the light generated from the light source, and a lens (not shown) for enlarging the projected image according to a predetermined focus distance. The projector module 155 can further include a device (not shown) for adjusting the direction in which the image is projected by mechanically moving the lens or the entire projector module 155.

The projector module 155 can be classified as a cathode ray tube (CRT) module, a liquid crystal display (LCD) module, or a digital light processing (DLP) module according to a type of display used. For example, the DLP module operates by enabling the light generated from the light source to reflect on a digital micro-mirror device (DMD) chip and can advantageously reduce the size of the projector module 155.

The projector module 155 can preferably be configured in a lengthwise direction along a side, front or back of the mobile terminal 100. It should be understood, however, that the projector module 155 can be configured on any portion of the mobile terminal 100.

The memory 160 can store various types of data to support the processing, control, and storage requirements of the mobile terminal 100. For example, such types of data can include program instructions for applications operated by the mobile terminal 100, contact data, phone book data, messages, audio, still images, and/or moving images.

A recent use history or a cumulative usage frequency of each type of data can be stored in the memory unit 160, such as usage frequency of each phonebook, message or multimedia. Moreover, data for various patterns of vibration and/or sound output when a touch input is performed on the touch screen can be stored in the memory unit 160.

Meanwhile, a discrimination value for discriminating whether one of the front and rear sides of the transparent display unit 151 faces toward a user is set and saved in the memory 160. The discrimination value shall be described in detail later.

The memory 160 can be implemented using any type or combination of suitable volatile and non-volatile memory or storage devices, such as a flash memory, a hard disk type memory, a multimedia card micro type memory, a card type memory, such as a Secure Digital (SD) card or Extreme Digital (xD) card, a random access memory (RAM), a static random access memory (SRAM), a read-only memory (ROM), an erasable programmable read-only memory (EPROM), a programmable ROM (PROM), an electrically erasable programmable read-only memory (EEPROM), a magnetic memory, a magnetic disk, an optical disk, or other type of memory or data storage device. In other embodiments, the memory 160 can be a storage device that can be accessed by the mobile terminal 100 via the Internet.

The interface unit 170 can couple the mobile terminal 100 to external devices. The interface unit 170 can receive data from the external devices or power, and transmit the data or power to internal components of the mobile terminal 100. In addition, the interface unit 170 can transmit data of the mobile terminal 100 to the external devices. The interface unit 170 can include, for example, a wired or wireless headset port, an external charger port, a wired or wireless data port, a memory card port, a port for connecting a device having an identity module, an audio input/output (I/O) port, a video I/O port, and/or an earphone port.

The identity module is the chip for storing various kinds of information for authenticating the authority to use the mobile terminal 100. For example, the identity module can be a user identify module (UIM), a subscriber identify module (SIM) or a universal subscriber identify module (USIM). A device including the identity module (hereinafter referred to as “identity device”) can also be manufactured in the form of a smart card. Therefore, the identity device can be connected to the mobile terminal 100 via a corresponding port of the interface unit 170.

When the mobile terminal 100 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 can control the general operations of the mobile terminal 100. For example, the controller 180 can be configured to perform control and processing associated with voice calls, data communication, and/or video calls. The controller 180 can perform pattern recognition processing to recognize a character or image from a handwriting input or a picture-drawing input performed on the touch screen.

The power supply unit 190 can be an external power source, an internal power source, or a combination thereof. The power supply unit 190 can supply power to other components in the mobile terminal 100.

A battery may include a built-in rechargeable battery and may be detachably attached to the terminal body for a charging and the like. A connecting port may be configured as one example of the interface 170 via which an external charger for supplying a power of a battery charging is electrically connected.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For example, the procedures or functions described herein can be implemented in software using separate software modules that allow performance of at least one function or operation. Software codes can be implemented by a software application or program written in any suitable programming language. The software codes can be stored in the memory 160 and executed by the controller 180.

In the following description of embodiments of the present disclosure, assume that the display unit 151 includes the transparent display unit 151 having the 1st and 2nd touch panels respectively provided to its front and rear sides, by which the embodiments of the present disclosure may be non-limited.

Meanwhile, according to an embodiment of the present disclosure, a user's touch action means a touch gesture implemented in a manner of performing a contact touch or a proximity touch on the display unit 151 of the touchscreen type. And, a touch input means an input received in response to the touch gesture.

The touch gesture may be categorized into one of a tapping, a touch & drag, a flicking, a press, a multi-touch, a pinch-in, a pinch out and the like in accordance with an action.

In particular, the tapping includes an action of lightly pressing and depressing the display unit 151 once and means a touch gesture such as a lock of a mouse of a normal personal computer.

The touch & drag is an action of touching the display unit, then moving the touch to a specific point by maintaining the touch to the display unit 151, and then releasing the touch from the display unit 151. When an object is dragged, the corresponding object can be displayed in a manner of moving continuously in a drag direction.

The flicking means an action of touching the display unit 151 and then performing a stroke in a specific direction (e.g., top direction, bottom direction, right direction, left direction, diagonal direction, etc.) at a specific speed (or strength). If a touch input of flicking is received, the mobile terminal 100 processes a specific operation based on a flicking direction, a flicking speed and the like.

The press means an action of touching the display unit 151 and then continuing the touch for preset duration at least. The multi-touch means an action of simultaneously touching a plurality of points on the display unit 151. The pinch-in means an action of dragging a plurality of pointers currently multi-touching the display unit 151 in an approaching direction. In particular, the pinch-in means a drag performed in a manner of starting with at least one of a plurality of points multi-touched on the display unit 151 and then progressing in a direction having a plurality of the multi-touched points get closer to each other.

The pinch-out means an action of dragging a plurality of pointers currently multi-touching the display unit 151 in a moving-away direction. In particular, the pinch-out means a drag performed in a manner of starting with at least one of a plurality of points multi-touched on the display unit 151 and then progressing in a direction having a plurality of the multi-touched points move away from each other.

FIG. 2A is a front perspective view of the mobile terminal 100 in accordance with one embodiment of the present disclosure. In FIG. 2A, the mobile terminal 100 is shown to have a bar type terminal body. However, it should be understood that the mobile terminal 100 is not limited to a bar type terminal body and can have various other body types. Examples of such body types include a slide type body, folder type body, swing type body, a rotational type body, or combinations thereof. Although the disclosure herein is primarily with respect to a bar-type mobile terminal 100, it should be understood that the disclosure can be applied to other types of mobile terminals.

As shown in FIG. 2A, the case of the mobile terminal 100 (otherwise referred to as a “casing,” “housing,” or “cover”) forming the exterior of the mobile terminal 100 can include a front case 101 and a rear case 102. Various electronic components are installed in the space between the front case 101 and the rear case 102. One or more intermediate cases can be additionally disposed between the front case 101 and the rear case 102. For example, the front case 101 and the rear case 102 can be made by injection-molding of a synthetic resin or can be made using a metal, such as stainless steel (STS) or titanium (Ti).

The display unit 151, the audio output module 152, the camera 121, user input modules 130a and 130b, the microphone 122, or the interface unit 170 can be situated on the mobile terminal 100, and specifically, on the front case 101. As shown in FIG. 2A, for example, the display unit 151 can be configured to occupy a substantial portion of the front face 156 of the front case 101. As also shown in FIG. 2A, the audio output unit 152 and the camera 121 can be arranged in proximity to one end of the display unit 151, and the user input module 131 and the microphone 122 can be located in proximity to another end of the display unit 151. As further shown in FIG. 2A, the user input module 132 and the interface unit 170 are arranged on the sides of the front case 101 and the rear case 102, such as sides 158 and 159, respectively.

The user input unit 130 described previously with respect to FIG. 1 can be configured to receive a command for controlling an operation of the mobile terminal 100 and can include one or more user input modules 131 and 132 shown in FIG. 2A. The user input modules 131 and 132 can each be referred to as a “manipulation unit” and can be configured to employ various methods and techniques of tactile manipulation and response to facilitate operation by the user.

The user input modules 131 and 132 can be configured for inputting different commands relative to one another. For example, the user input module 131 can be configured allow a user to input such commands as “start,” “end,” and “scroll” to the mobile terminal 100. The user input module 132 can allow a user to input a command for adjusting the volume of the audio output unit 152 or a command for switching to a touch recognition mode of the display unit 151.

FIG. 2B is a rear perspective view of the mobile terminal 100 in accordance with one embodiment of the present disclosure. As shown in FIG. 2B, a camera 121′ can be additionally located on a rear surface 161 of the rear case 102. The camera 121′ has a direction of view that is substantially opposite to the direction of view of the camera 121 shown in FIG. 2A. The cameras 121 and 121′ can have different resolutions, or different pixels counts, with respect to one another.

For example, the camera 121 can operate with a relatively lower resolution than the camera 121′ in order to capture an image of the user to allow immediate transmission of the image to another user in real-time for a video call, whereas the camera 121′ can operate with a relatively higher resolution than the camera 121 to capture images of general objects with high picture quality, which may not require immediate transmission in real-time, and may be stored for later viewing or use. For example, the cameras 121 and the camera 121′ can be configured to rotate or to pop-up on the mobile terminal 100.

Additional camera related components, such as a flash 123 and a mirror 124, can be located adjacent to the camera 121′. When an image of a subject is captured with the camera 121′, the flash 123 illuminates the subject. The mirror 124 allows self-image capturing by allowing the user to see himself when the user desires to capture his own image using the camera 121′.

The rear surface 161 of the rear case 102 can further include a second audio output module 152′. The second audio output module 152′ can support a stereo sound function in conjunction with the audio output module 152 shown in FIG. 2A and can be used for communication during a phone call when the mobile terminal 100 is in a speaker phone mode.

A broadcasting signal receiving antenna 116 can be additionally attached to the side of the body of the mobile terminal 100 in addition to an antenna used for telephone calls. The broadcasting signal receiving antenna 116 can form a part of the broadcast receiving module 111 shown in FIG. 1, and can be set in the body of the mobile terminal 100 such that the broadcasting signal receiving antenna can be pulled out and retracted into the body of the mobile terminal 100.

FIG. 2B shows the power supply unit 190 for providing power to the mobile terminal 100. For example, the power supply unit 190 can be situated either inside the mobile terminal 100 or detachably coupled to the mobile terminal 100.

As shown in FIG. 2B, a touch pad 135 for sensing a touch by the user can be located on the rear surface 161 of the rear case 102. In one embodiment, the touch pad 135 and the display unit 151 can be translucent such that the information displayed on display unit 151 can be output on both sides of the display unit 151 and can be viewed through the touch pad 135. The information displayed on the display unit 151 can be controlled by the touch pad 135. In another embodiment, a second display unit in addition to display unit 151 illustrated in FIG. 2A can be located on the rear surface 161 of the rear case 102 and combined with the touch pad 135 to form a touch screen on the rear case 102.

The touch pad 135 is activated by interconnecting with the display unit 151 of the front case 101. The touch pad 135 can be located in parallel with the display unit 151 and behind the display unit 151. The touch pad 135 can have the same or smaller size than the display unit 151.

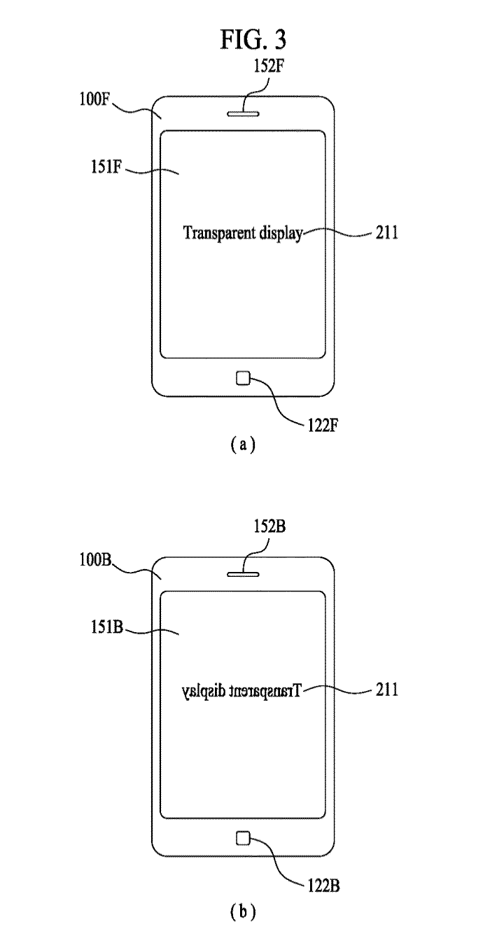

FIGS. 3 to 5 are perspective diagrams of front and rear side of a mobile terminal having a transparent display unit according to the present disclosure. Referring to FIG. 3, an exterior case of the mobile terminal 100 includes a bezel at the minimum. Various keys included in the user input unit 130 for the operation manipulation of the mobile terminal 100 are displayed as touch keys on the transparent display unit 151 or may be provided to lateral sides of the mobile terminal 100.

FIG. 3 (a) shows a front side of the mobile terminal 100 having the transparent display unit 151. A 1st audio output module 152F and a 1st microphone 122F are provided to the front side of the mobile terminal 100. When the front side 151F of the transparent display unit 151 faces toward a user, specific information 211 viewed by the user is displayed on the front side 151F of the transparent display unit 151.

FIG. 3 (b) shows a rear side of the mobile terminal 100 having the transparent display unit 151. And, a 2nd audio output module 152B and a 2nd microphone 122B are provided to the rear side of the mobile terminal 100. In particular, when a user starts a call or is making a call, although the user holds the mobile terminal 100 in a manner that the rear side of the mobile terminal 100 faces toward the user, the user can listen to a counterpart's voice or input a user's voice through the 2nd audio output module 152B and the 2nd microphone 122B.

Referring to FIG. 3 (b), when the rear side 151B of the transparent display unit 151 faces toward the user, the specific information 211 viewed by the user is reversely displayed on the rear side 151B of the transparent display unit 151. In doing so, according to the present disclosure, based on at least one state of the mobile terminal 100, whether the rear side 151B of the mobile terminal 100 faces toward the user is automatically detected and the information reversely displayed on the rear side 151B is reversely displayed again. Therefore, the user can view the information in a correct direction through the rear side 151B of the transparent display unit 151.

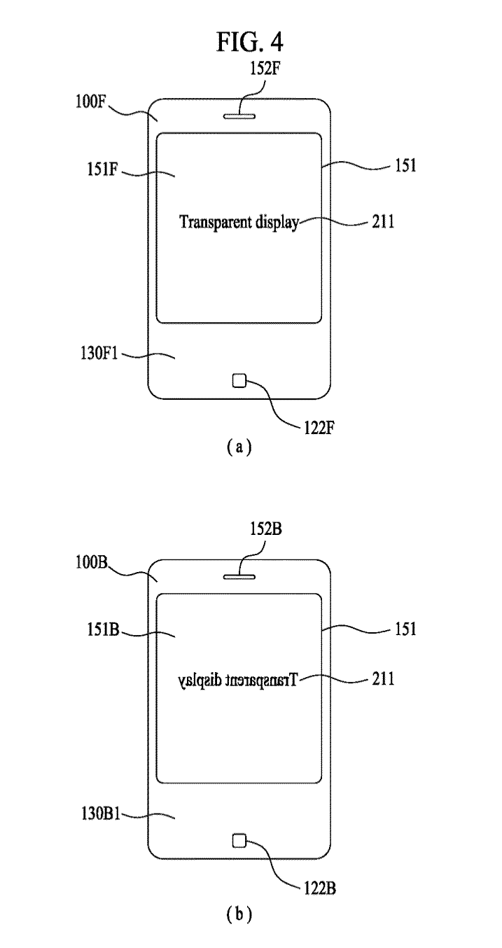

Referring to FIG. 4, various keys included in the user input unit 130 are arranged on 1st and 2nd bottom regions 130F1 and 130B1 of the front and rear cases of the mobile terminal 100. In this case, the rest parts of the front and rear cases except the 1st and 2nd bottom regions 130F1 and 130B1 can be configured with a bezel at the minimum.

FIG. 4 (a) shows a front side of the mobile terminal 100 having the transparent display unit 151. A 1st audio output module 152F and a 1st microphone 122F are provided to the front side of the mobile terminal 100. Various keys for various operation manipulations, which are included in the user input unit 130, are provided as physical keys and/or touch keys to the 1st bottom region 130F1 of the front side of the mobile terminal 100. For instance, the key provided to the 1st bottom region 130F1 may include a key provided to a bottom region of a smartphone in general.

FIG. 4 (b) shows a rear side of the mobile terminal 100 having the transparent display unit 151. And, a 2nd audio output module 152B and a 2nd microphone 122B are provided to the rear side of the mobile terminal 100. Various keys for various operation manipulations, which are included in the user input unit 130, are provided as physical keys and/or touch keys to the 2nd bottom region 130B1 of the rear side of the mobile terminal 100. For instance, the keys provided to the 2nd bottom region 130B1 may include a screen-on key, a camera activate key, a volume-up/down key and the like.

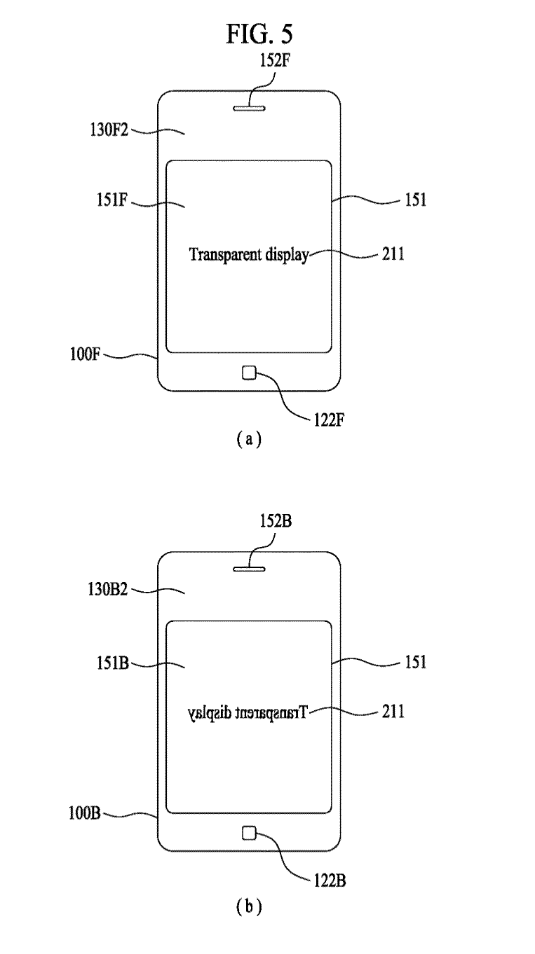

Referring to FIG. 5, various keys included in the user input unit 130 are arranged on 1st and 2nd top regions 130F2 and 130B2 of the front and rear cases of the mobile terminal 100. In this case, the rest parts of the front and rear cases except the 1st and 2nd top regions 130F2 and 130B2 can be configured with a bezel at the minimum.

FIG. 5 (a) shows a front side of the mobile terminal 100 having the transparent display unit 151. A 1st audio output module 152F and a 1st microphone 122F are provided to the front side 151F of the mobile terminal 100. Various keys for various operation manipulations, which are included in the user input unit 130, are provided as physical keys and/or touch keys to the 1st top region 130F2 of the front side of the mobile terminal 100. For instance, the key provided to the 1st top region 130F2 may include a key provided to a bottom region of a smartphone in general.

FIG. 5 (b) shows a rear side of the mobile terminal 100 having the transparent display unit 151. And, a 2nd audio output module 152B and a 2nd microphone 122B are provided to the rear side of the mobile terminal 100. Various keys for various operation manipulations, which are included in the user input unit 130, are provided as physical keys and/or touch keys to the 2nd top region 130B2 of the rear side of the mobile terminal 100. For instance, the keys provided to the 2nd top region 130B2 may include a screen-on key, a camera activate key, a volume-up/down key and the like.

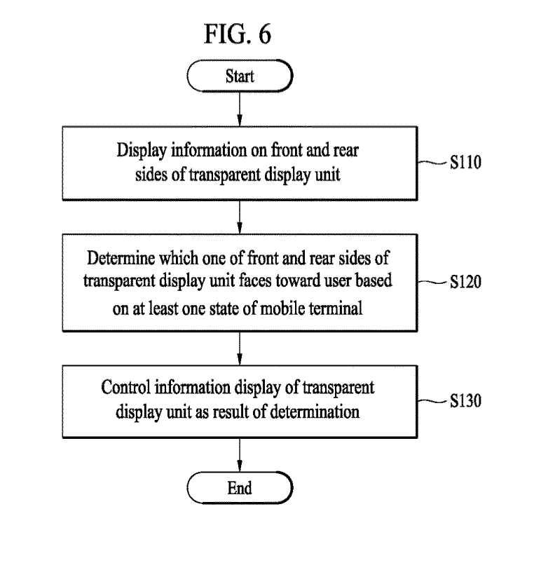

In the following description, a process for, based on at least one state of the mobile terminal 100, determining whether which one of the front and rear sides of the transparent display unit 151 faces toward a user and then controlling an information display of the transparent display unit 151 depending on a result of the determination is explained in detail with reference to FIGS. 6 to 24.

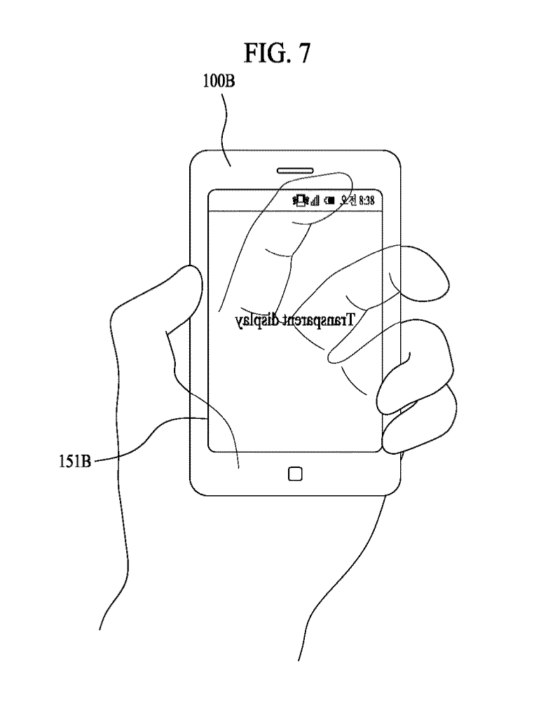

FIG. 6 is a flowchart for a method of controlling an information display in a mobile terminal according to the present disclosure. FIGS. 7 to 24 are diagrams to describe a method of controlling an information display in a mobile terminal according to the present disclosure.

Referring to FIG. 6, the controller 180 of the mobile terminal 100 displays information on the front side 151F and the rear side 151B of the transparent display unit 151 [S110]. Based on at least one state of the mobile terminal 100 according to the present disclosure, the controller 180 of the mobile terminal 100 determines whether which one of the front side 151F and the rear side 151B of the transparent display unit 151 faces toward a user [S120].

In the following description, a process for determining whether which one of the front and rear sides 151F and 151B of the transparent display unit 151 faces toward a user based on at least one state of the mobile terminal 100 is explained in detail with reference to FIGS. 7 to 24.

First of all, at least one state of the mobile terminal can include at least one attribute of a contact touch inputted to at last one of the front touch panel and the rear touch panel of the transparent display unit 151 when the rear side 151B of the transparent display unit 151 faces toward a user by a user's grasp of the mobile terminal 100.

For instance, FIG. 7 shows a state that a user grasps the mobile terminal 100 with one hand in order for the rear side of the mobile terminal 100 to face toward the user. In this case, the at least one state of the mobile terminal 100 can include a range value of an electrostatic strength by a touch inputted to the front touch panel of the transparent display unit 151 while the rear side 151B is facing toward the user.

In particular, when the user grasps the mobile terminal 100 in order for the rear side 151B of the transparent display unit 151 to face toward the user, a palm or at least one finger of the user touches the front side 151F of the transparent display unit 151.

In this case, the range value of the electrostatic strength may become an average of the electrostatic strengths attributed to the palm or at least one finger of the user, which are sensed from the touch panel of the front side 151F when the user grasps the mobile terminal 100 to enable the rear side 151B to face the user.

In particular, when the at least one state of the mobile terminal 100 includes the range value of the electrostatic strength attributed to the touch inputted to the touch panel of the front side 151F of the transparent display unit 151, if the electrostatic strength of the touch inputted to the touch panel of the front side 151F of the transparent display unit 151 currently belongs to the range value, the controller 180 determines that the rear side 151B of the transparent display unit 151 currently faces toward the user.

Moreover, the at least one state of the mobile terminal 100 can include a range value of an electrostatic strength by a touch inputted to the rear touch panel of the transparent display unit 151 while the front side 151F is facing toward the user. In particular, when the user grasps the mobile terminal 100 in order for the front side 151F of the transparent display unit 151 to face toward the user, a palm or at least one finger of the user touches the rear side 151B of the transparent display unit 151.

In this case, the range value of the electrostatic strength may become an average of the electrostatic strengths attributed to the palm or at least one finger of the user, which are sensed from the touch panel of the rear side 151B when the user grasps the mobile terminal 100 to enable the front side 151F to face the user.

In particular, when the at least one state of the mobile terminal 100 includes the range value of the electrostatic strength attributed to the touch inputted to the touch panel of the rear side 151B of the transparent display unit 151, if the electrostatic strength of the touch inputted to the touch panel of the rear side 151B of the transparent display unit 151 currently belongs to the range value, the controller 180 determines that the front side 151F of the transparent display unit 151 currently faces toward the user. The range value may be a prescribed value, e.g., threshold value, associated with a user holding the mobile terminal.

Moreover, the at least one state of the mobile terminal 100 can include a range value of a space size (or area) of a touch inputted to the touch panel of the front side 151F of the transparent display unit 151 while the rear side 151B is facing toward the user. In particular, when the user grasps the mobile terminal 100 in order for the rear side 151B of the transparent display unit 151 to face toward the user, a palm or at least one finger of the user touches the front side 151F of the transparent display unit 151.

In this case, the range value of the touch space size may become an average of the touch space sizes attributed to the palm or at least one finger of the user, which are sensed from the touch panel of the front side 151F when the user grasps the mobile terminal 100 to enable the rear side 151B to face the user.

In particular, when the at least one state of the mobile terminal 100 includes the range value of the touch space size of the touch inputted to the touch panel of the front side 151F of the transparent display unit 151, if the space size of the touch inputted to the touch panel of the front side 151F of the transparent display unit 151 currently belongs to the range value, the controller 180 determines that the rear side 151B of the transparent display unit 151 currently faces toward the user.

Moreover, at least one state of the mobile terminal 100 can include a range value of a space size (or area) of a touch inputted to the touch panel of the rear side 151B of the transparent display unit 151 while the front side 151F is facing toward the user. In particular, when the user grasps the mobile terminal 100 in order for the front side 151F of the transparent display unit 151 to face toward the user, a palm or at least one finger of the user touches the rear side 151B of the transparent display unit 151.

In this case, the range value of the touch space size may become an average of the touch space sizes attributed to the palm or at least one finger of the user, which are sensed from the touch panel of the rear side 151B when the user grasps the mobile terminal 100 to enable the front side 151F to face the user.

In particular, when the at least one state of the mobile terminal 100 includes the range value of the touch space size of the touch inputted to the touch panel of the rear side 151B of the transparent display unit 151, if the space size of the touch inputted to the touch panel of the rear side 151B of the transparent display unit 151 currently belongs to the range value, the controller 180 determines that the front side 151F of the transparent display unit 151 currently faces toward the user.

Moreover, the at least one state of the mobile terminal 100 can include a space shape of a touch inputted to the touch panel of the front side 151F of the transparent display unit 151 while the rear side 151B is facing toward the user. In particular, when the user grasps the mobile terminal 100 in order for the rear side 151B of the transparent display unit 151 to face toward the user, a palm or at least one finger of the user in a specific shape (e.g., a palm shape, etc.) or a specific pattern (e.g., a multi-line pattern, etc.) touches the front side 151F of the transparent display unit 151. Hence, the at least one state of the mobile terminal 100 can become the touch space shape including the specific shape or the specific pattern.

In this case, when the at least one state of the mobile terminal 100 includes the space shape, if the shape of the space of the touch inputted to the touch panel of the front side 151F of the transparent display unit 151 is similar to or coincides with the touch space shape attributed to the at least one state of the mobile terminal 100 currently, the controller 180 determines that the rear side 151B of the transparent display unit 151 currently faces toward the user.

Moreover, the at least one state of the mobile terminal 100 can include a space shape of a touch inputted to the touch panel of the rear side 151B of the transparent display unit 151 while the front side 151F is facing toward the user. In particular, when the user grasps the mobile terminal 100 in order for the front side 151F of the transparent display unit 151 to face toward the user, a palm or at least one finger of the user in a specific shape (e.g., a palm shape, etc.) or a specific pattern (e.g., a multi-line pattern, etc.) touches the rear side 151B of the transparent display unit 151. Hence, the at least one state of the mobile terminal 100 can become the touch space shape including the specific shape or the specific pattern.

In this case, when the at least one state of the mobile terminal 100 includes the space shape, if the shape of the space of the touch inputted to the touch panel of the rear side 151B of the transparent display unit 151 is similar to or coincides with the touch space shape attributed to the at least one state of the mobile terminal 100 currently, the controller 180 determines that the front side 151F of the transparent display unit 151 currently faces toward the user.

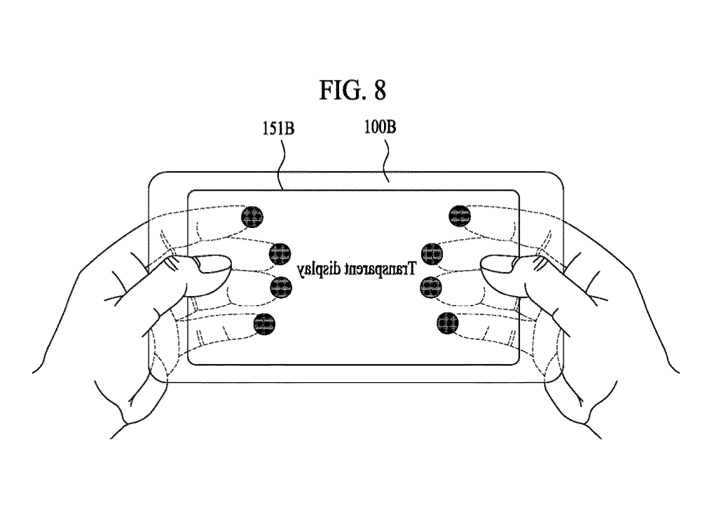

For another instance, FIG. 8 shows a state that a user grasps the mobile terminal 100 with both hands to enable the rear side of the mobile terminal 100 to face toward the user. In this case, the at least one state of the mobile terminal 100 may include the preset number value of touches inputted to the touch panel of the front side 151F of the transparent display unit 151 while the rear side 151B is facing toward the user.

In particular, when the user grasps the mobile terminal 100 to enable the rear side 151B of the transparent display unit 151 to face toward the user, the user can hold the mobile terminal 100 using fingers of both of the hands. In doing so, the fingers of both of the hands of the user touch several points on the front side 151F of the transparent display unit 151.

In more particular, when the at least one state of the mobile terminal 100 includes the preset touch number, if the number of the touches inputted to the touch panel of the front side 151F of the transparent display unit 151 is equal to or greater than the preset touch number, the controller 180 determines that the rear side 151B of the transparent display unit 151 currently faces toward the user. For example, the preset touch number may be equal to or greater than 2.

Moreover, the at least one state of the mobile terminal 100 may include the preset number value of touches inputted to the touch panel of the rear side 151B of the transparent display unit 151 while the front side 151F is facing toward the user. In particular, when the user grasps the mobile terminal 100 to enable the front side 151F of the transparent display unit 151 to face toward the user, the user can hold the mobile terminal 100 using fingers of both of the hands. In doing so, the fingers of both of the hands of the user touch several points on the rear side 151B of the transparent display unit 151.

In more particular, when the at least one state of the mobile terminal 100 includes the preset touch number, if the number of the touches inputted to the touch panel of the rear side 151B of the transparent display unit 151 is equal to or greater than the preset touch number, the controller 180 determines that the front side 151F of the transparent display unit 151 currently faces toward the user.

Moreover, the at least one state of the mobile terminal 100 may include a location range value of a region, to which a touch will be inputted, on the touch panel of the front side 151F of the transparent display unit 151 while the rear side 151B is facing toward the user. In particular, when the user grasps the mobile terminal 100 to enable the rear side 151B of the transparent display unit 151 to face toward the user, the user can hold the mobile terminal 100 using one or both hands of the user. In doing so, one or both of the hands of the user touch a region corresponding to one or both lateral sides of the front side 151F of the transparent display unit 151.

In this case, the location range value of the region, to which the touch will be inputted, can include at least one of an average location value of at least one lateral side region (e.g., a left lateral side, a right lateral side, etc.) to be touched with one hand of the user in a display region of the front side 151F and an average location value of both lateral side regions (e.g., a left lateral side and a right lateral side) to be touched with both hands of the user in the display region of the front side 151F.

In particular, if the at least one state of the mobile terminal 100 includes the location range value, the controller 180 obtains a location of the touch inputted to the front side 151F. If the obtained touch location belongs to the location range value, the controller 180 determines that the rear side 151B faces toward the user.

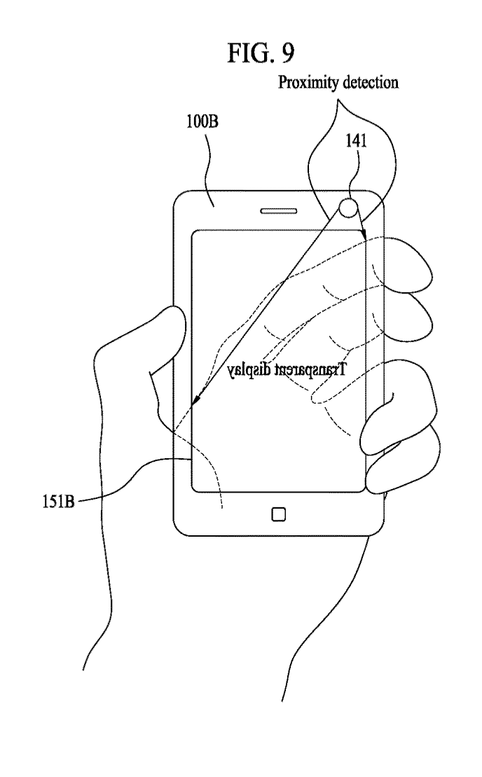

Referring to FIG. 9, the at least one state of the mobile terminal 100 can include at least one attribute of a proximity touch inputted to at least one of the front touch panel and the rear touch panel of the transparent display unit 151 while the rear side 151B of the transparent display unit 151 is facing toward a user by a grasp at the mobile terminal 100.

According to the present disclosure, referring to FIG. 9, the proximity sensor 141 can be arranged on the front side 100F of the mobile terminal 100. In this case, the at least one state of the mobile terminal 100 can include a range value of a proximity distance of a proximity touch sensed by the proximity sensor 141 arranged on the front side 100F of the mobile terminal 100 while the rear side 151B of the transparent display unit 151 is facing toward the user.

In particular, when a user grasps the mobile terminal 100 to enable the rear side 151B of the transparent display unit 151 to face toward the user, a palm or at least one finger of the user approaches the front side 100F of the mobile terminal 100. In doing so, the controller 180 senses a proximity distance of the user's hand to the front side 100F of the mobile terminal 100 through the proximity sensor 141 arranged on the front side 100F. If the sensed proximity distance belongs to the range value of the proximity distance according to the at least one state of the mobile terminal 100, the controller 180 determines that the rear side 151B of the transparent display unit 151 currently faces toward the user.

Moreover, according to the present disclosure, the proximity sensor 141 can be arranged on the rear side 100B of the mobile terminal 100. In this case, the at least one state of the mobile terminal 100 can include a range value of a proximity distance of a proximity touch sensed by the proximity sensor 141 arranged on the rear side 100B of the mobile terminal 100 while the front side 151F of the transparent display unit 151 is facing toward the user.

In particular, when a user grasps the mobile terminal 100 to enable the front side 151F of the transparent display unit 151 to face toward the user, a palm or at least one finger of the user approaches the rear side 100B of the mobile terminal 100. In doing so, the controller 180 senses a proximity distance of the user's hand to the rear side 100B of the mobile terminal 100 through the proximity sensor 141 arranged on the rear side 100B. If the sensed proximity distance belongs to the range value of the proximity distance according to the at least one state of the mobile terminal 100, the controller 180 determines that the front side 151F of the transparent display unit 151 currently faces toward the user.

Moreover, the proximity sensor 141 can be arranged on the front side 100F of the mobile terminal 100. In this case, the at least one state of the mobile terminal 100 may include a location range value of a region, to which a proximity touch will be inputted, on the front side 151F of the transparent display unit 151 while the rear side 151B is facing toward the user.

In particular, when the user grasps the mobile terminal 100 to enable the rear side 151B of the transparent display unit 151 to face toward the user, the user can hold the mobile terminal 100 using one or both hands of the user. In doing so, one or both of the hands of the user perform a proximity touch on a region corresponding to one or both lateral sides of the front side 151F of the transparent display unit 151.

In this case, the location range value of the region, to which the proximity touch will be inputted, can include at least one of an average location value of at least one lateral side region (e.g., a left lateral side, a right lateral side, etc.) to be touched with one hand of the user in a display region of the front side 151F and an average location value of both lateral side regions (e.g., a left lateral side and a right lateral side) to be touched with both hands of the user in the display region of the front side 151F.

In particular, if the at least one state of the mobile terminal 100 includes the location range value, the controller 180 obtains a location of the proximity touch inputted to the front side 151F from the proximity sensor 141. If the obtained proximity touch location belongs to the location range value, the controller 180 determines that the rear side 151B faces toward the user.

Moreover, the proximity sensor 141 can be arranged on the rear side 100B of the mobile terminal 100. In this case, the at least one state of the mobile terminal 100 may include a location range value of a region, to which a proximity touch will be inputted, on the rear side 151B of the transparent display unit 151 while the front side 151F is facing toward the user.

In particular, when the user grasps the mobile terminal 100 to enable the front side 151F of the transparent display unit 151 to face toward the user, the user can hold the mobile terminal 100 using one or both hands of the user. In doing so, one or both of the hands of the user perform a proximity touch on a region corresponding to one or both lateral sides of the rear side 151B of the transparent display unit 151.

In this case, the location range value of the region, to which the proximity touch will be inputted, can include at least one of an average location value of at least one lateral side region (e.g., a left lateral side, a right lateral side, etc.) to be touched with one hand of the user in a display region of the rear side 151B and an average location value of both lateral side regions (e.g., a left lateral side and a right lateral side) to be touched with both hands of the user in the display region of the rear side 151B.

In particular, if the at least one state of the mobile terminal 100 includes the location range value, the controller 180 obtains a location of the proximity touch inputted to the rear side 151B from the proximity sensor 141. If the obtained proximity touch location belongs to the location range value, the controller 180 determines that the front side 151F faces toward the user.

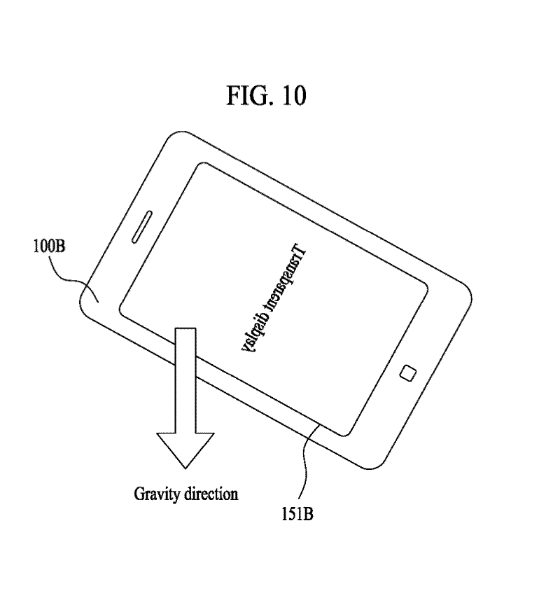

In the following description with reference to FIG. 10, the at least one state of the mobile terminal 100 can include a direction of gravity direction sensed through the motion sensor 142. When one of the front side 151F and the rear side 151B of the transparent display unit 151 faces toward a user by a user's grasp at the mobile terminal 100, the controller 180 senses a gravity direction of the mobile terminal through the motion sensor 142.

In doing so, since a normal gravity direction is a direction opposite to a direction toward the user with reference to the transparent display unit 151, the controller 180 determines that one of the front side 151F and the rear side 151B of the transparent display unit 151, which is located in the direction opposite to the gravity direction sense through the motion sensor 142, is located in the direction toward the user.

For instance, when the user grasps the mobile terminal 100 to enable the rear side 151B of the transparent display unit 151 to face toward the user, since the rear side 151B is opposite to the gravity direction, the controller 180 provides the user with an information displayed in a correct direction by reversing the information reversely displayed on the rear side 151B again.

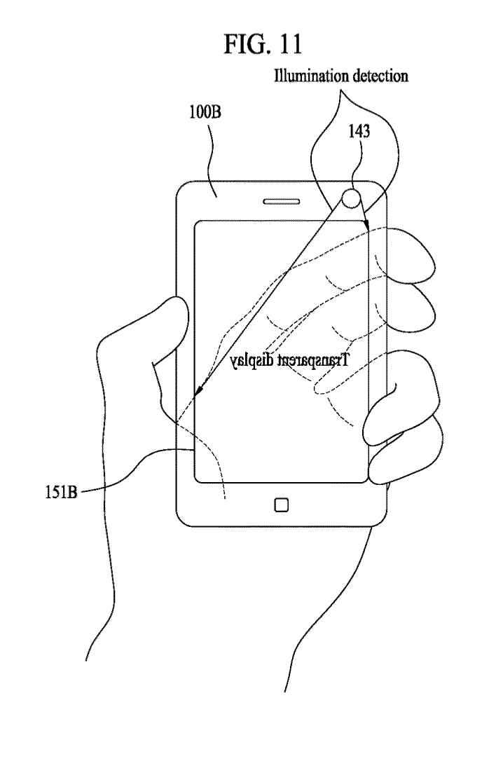

In the following description with reference to FIG. 11, the at least one state of the mobile terminal 100 can include a surrounding illumination sensed through the illumination sensor 143. The illumination sensor 143 can be arranged on the front side 100F of the mobile terminal 100. In this case, the at least one state of the mobile terminal 100 can include a surrounding illumination (or a front illumination) sensed through the illumination sensor 143 arranged on the front side 100F of the mobile terminal 100 while the rear side 151B of the transparent display unit 151 is facing toward a user.

In particular, when the user grasps the mobile terminal 100 to enable the rear side 151B of the transparent display unit 151 to face toward the user, a palm or at least one finger of the user proximately touches or contacts with the illumination sensor arranged part of the front side 100F of the mobile terminal 100. Hence, a surrounding illumination value sensed by the illumination sensor 143 is changed.

Thus, if the controller 180 detects that the front or surrounding illumination of the front side 100F is changed over a preset illumination value through the illumination sensor 143 arranged on the front side 100F, the controller 180 determines that the rear side 151B of the transparent display unit 151 currently faces toward the user.

On the other hand, the illumination sensor 143 can be arranged on the rear side 100B of the mobile terminal 100. In this case, the at least one state of the mobile terminal 100 can include a surrounding illumination (or a front illumination) sensed through the illumination sensor 143 arranged on the rear side 100B of the mobile terminal 100 while the front side 151F of the transparent display unit 151 is facing toward a user.

In particular, when the user grasps the mobile terminal 100 to enable the front side 151F of the transparent display unit 151 to face toward the user, a palm or at least one finger of the user proximately touches or contacts with the illumination sensor arranged part of the rear side 100B of the mobile terminal 100. Hence, a surrounding illumination value sensed by the illumination sensor 143 is changed.

Thus, if the controller 180 detects that the front or surrounding illumination of the rear side 100B is changed over a preset illumination value through the illumination sensor 143 arranged on the rear side 100B, the controller 180 determines that the front side 151F of the transparent display unit 151 currently faces toward the user.

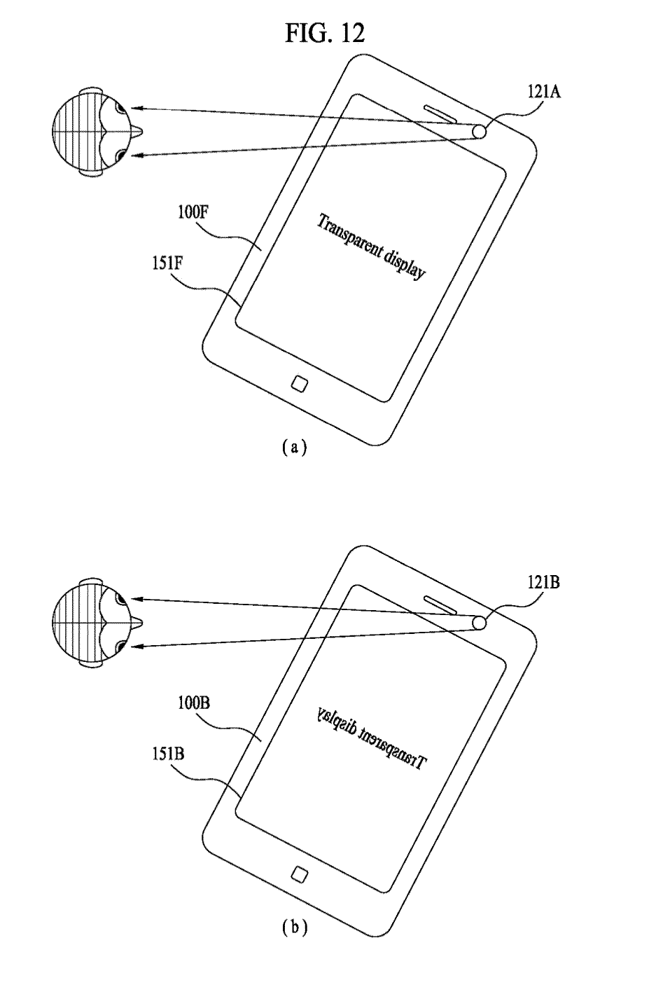

In the following description with reference to FIG. 12, the at least one state of the mobile terminal 100 can include an image containing a user's face inputted through the camera 121. Referring to FIG. 12 (a), according to the present disclosure, the camera 121F can be arranged on the front side 100F of the mobile terminal 100. In this case, the at least one state of the mobile terminal 100 can include an image containing a user's face inputted through the camera 121F arranged on the front side 100F of the mobile terminal 100 when the front side 151F of the transparent display unit 151 faces toward the user.

In particular, when the user grasps the mobile terminal 100 to enable the front side 151F of the transparent display unit 151 to face toward the user, a user's face is contained in the image inputted from the camera 121F arranged on the front side 100F of the mobile terminal 100. In this case, a user's reference image referred to for a user's face recognition is saved in the memory 160. The controller 180 compares the image inputted through the camera 121F provided to the front side 100F of the mobile terminal 100 to the user's reference image saved in the memory 160. If the user's face is recognized as contained in the inputted image, the controller 180 determines that the front side 151F of the transparent display unit 151 currently faces toward the user.

Referring to FIG. 12 (b), according to the present disclosure, the camera 121B can be arranged on the rear side 100B of the mobile terminal 100. In this case, the at least one state of the mobile terminal 100 can include an image containing a user's face inputted through the camera 121B arranged on the rear side 100B of the mobile terminal 100 when the rear side 151B of the transparent display unit 151 faces toward the user.

In particular, when the user grasps the mobile terminal 100 to enable the rear side 151B of the transparent display unit 151 to face toward the user, a user's face is contained in the image inputted from the camera 121B arranged on the rear side 100B of the mobile terminal 100. In this case, a user's reference image referred to for a user's face recognition is saved in the memory 160. The controller 180 compares the image inputted through the camera 121B provided to the rear side 100B of the mobile terminal 100 to the user's reference image saved in the memory 160. If the user's face is recognized as contained in the inputted image, the controller 180 determines that the rear side 151B of the transparent display unit 151 currently faces toward the user.

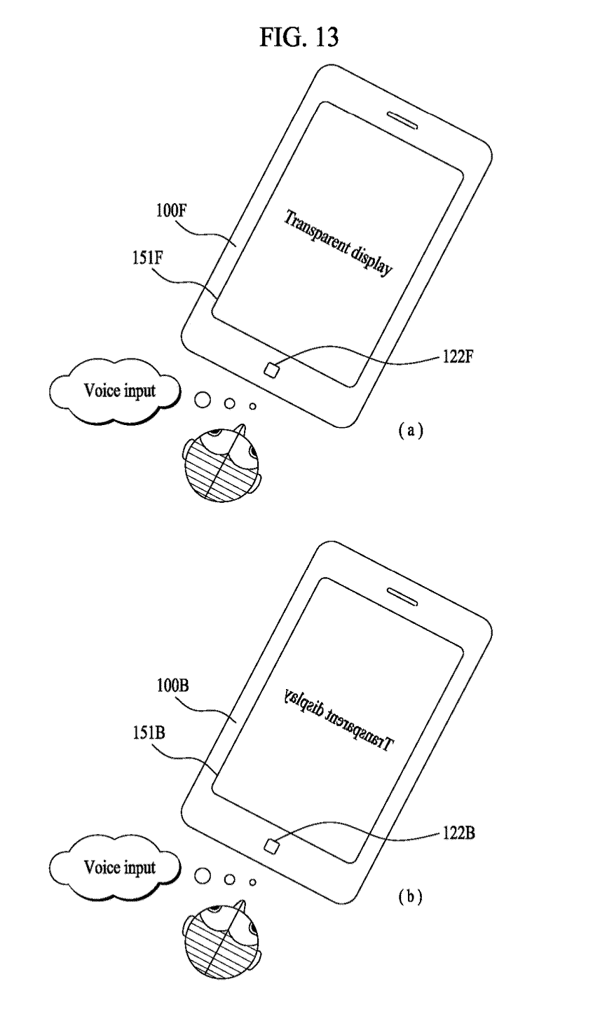

In the following description with reference to FIG. 13, the at least one state of the mobile terminal 100 can include a voice inputted through the microphone 122. Referring to FIG. 13 (a), according to the present disclosure, the microphone 122F can be arranged on the front side 100F of the mobile terminal 100. In this case, the at least one state of the mobile terminal 100 can include a user's voice inputted through the microphone 122F arranged on the front side 100F of the mobile terminal 100 when the front side 151F of the transparent display unit 151 faces toward the user.

In particular, when the user grasps the mobile terminal 100 to enable the front side 151F of the transparent display unit 151 to face toward the user, if a user's voice is inputted through the microphone 122F arranged on the front side 100F of the mobile terminal 100, the controller 180 determines that the front side 151F of the transparent display unit 151 currently faces toward the user.

Referring to FIG. 13 (b), according to the present disclosure, the microphone 122B can be arranged on the rear side 100B of the mobile terminal 100. In this case, the at least one state of the mobile terminal 100 can include a user's voice inputted through the microphone 122B arranged on the rear side 100B of the mobile terminal 100 when the rear side 151B of the transparent display unit 151 faces toward the user.

In particular, when the user grasps the mobile terminal 100 to enable the rear side 151B of the transparent display unit 151 to face toward the user, if a user's voice is inputted through the microphone 122B arranged on the rear side 100B of the mobile terminal 100, the controller 180 determines that the rear side 151B of the transparent display unit 151 currently faces toward the user.

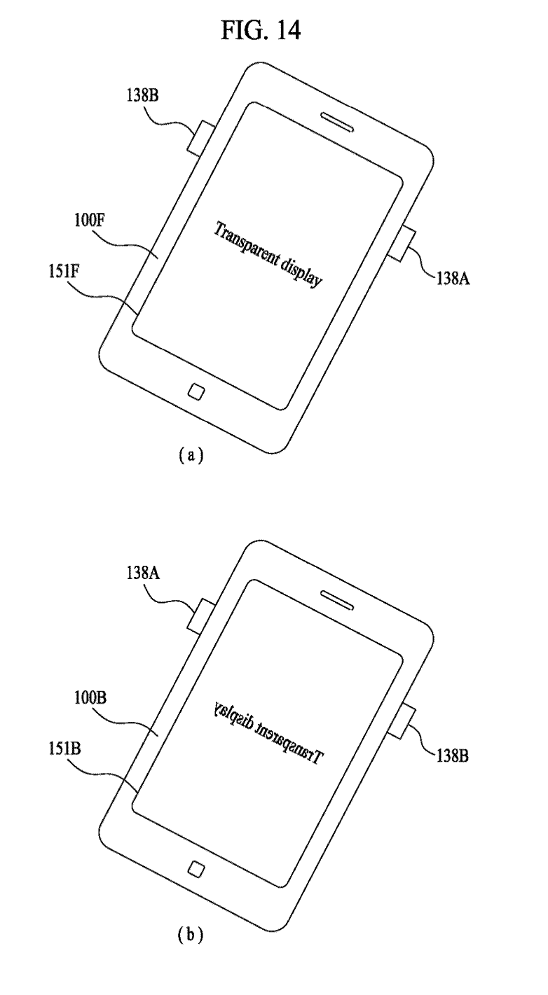

In the following description with reference to FIG. 14, the at least one state of the mobile terminal 100 can include inputs of 1st and 2nd keys 138A and 138B respectively provided to both lateral sides of the mobile terminal 100. Referring to FIG. 14 (a), with reference to the front side 100F of the mobile terminal 100, the 1st key 138A having a 1st function assigned thereto is provided to one of the right and left lateral sides of the mobile terminal 100 and the 2nd key 138B having a 2nd function assigned thereto is provided to the other.

In this case, a screen power on/off function is assigned to the 1st key 138A and other function except the screen power on/off function is assigned to the 2nd key 138B. For instance, a memo input function for inputting a memo to a screen can be assigned to the 2nd key 138B.

In particular, while the screen of the transparent display unit 151 is turned off, if the 1st key 138A is inputted, the controller 180 determines that the front side 151F of the transparent display unit 151 faces toward a user, turns on the screen of the transparent display unit 151, and controls information to be displayed on the front side 151F of the turned-on transparent display unit 151.

Referring to FIG. 14 (b), while the screen of the transparent display unit 151 is turned off, if the 2nd key 138B is inputted, the controller 180 determines that the rear side 151B of the transparent display unit 151 faces toward a user, swaps the function assigned to the inputted 2nd key 138B for the screen on/off function assigned to the 1st key 138A, and turns on the screen of the transparent display unit 151.

Referring now to FIG. 6, step S130 is described in further detail below. First of all, as mentioned in the above description, based on the contents described with reference to FIGS. 7 to 14, if the step S120 shown in FIG. 6 is complete, the controller 180 determines whether one of the front side 151F and the rear side 151B of the transparent display unit 151 currently faces toward the user based on the at least one state of the mobile terminal 100. As a result of the determination, the controller 180 controls an information display of the transparent display unit 151 [S130].

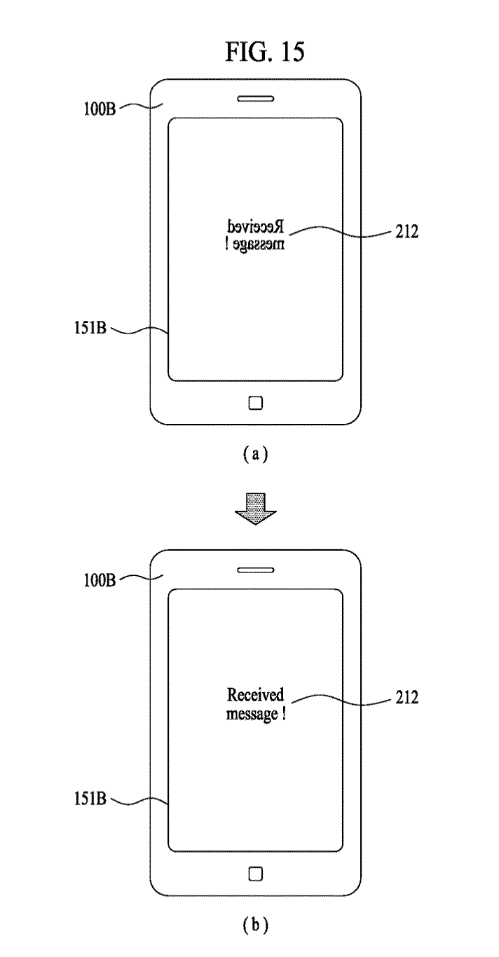

In the following description, a process for controlling an information display operation of a side (e.g., the front side 151F of the transparent display unit 151, the rear side 151B of the transparent display unit 151, etc.) facing toward a user in the step S130 is explained in detail with reference to FIGS. 15 to 24.

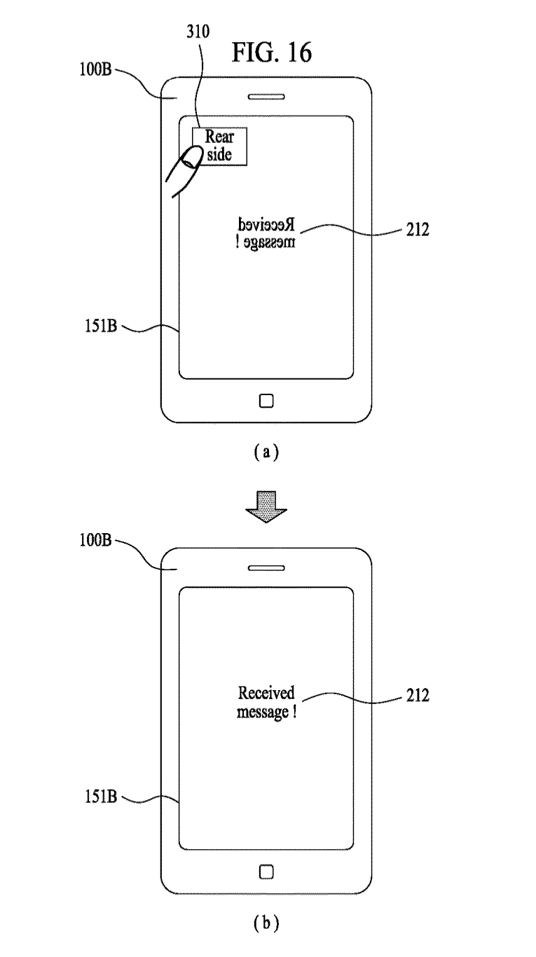

First of all, referring to FIG. 15 and FIG. 16, based on the at least one state of the mobile terminal 100 according to the step S120, if the controller 180 determines that the rear side 151B of the transparent display unit 151 faces toward the user, the controller 180 can control a content displayed on the rear side 151B to be displayed in a manner of being reversed to enable the user to view in a correct direction.

In particular, referring to FIG. 15 (a), as the mobile terminal 100 is turned over by a user's grasp at the mobile terminal 100, the rear side 151B of the transparent display unit 151 faces toward the user. Hence, a specific content 212, which was previously displayed on the front side 151F of the transparent display unit 151 before the mobile terminal 100 is turned over, is displayed in reverse.

In the following description of the present disclosure, the contents 212 may include at least one of all data runnable in the mobile terminal 100, all functions runnable in the mobile terminal 100 and all images displayable on the mobile terminal 100. For instance, the content 212 may include at least one of multimedia, media, broadcast, video, music, photo, game, document, webpage, map, navigation, menu function, application, widget, home screen, standby screen, camera preview image, messenger, e-dictionary, e-book, gallery and the like.

Based on the at least one state of the mobile terminal 100, if determining that the rear side 151B of the transparent display unit 151 currently faces toward the user, referring to FIG. 15 (b), the controller 180 controls the content 212 to be reversely displayed on the rear side 151B of the transparent display unit 151.

Referring to FIG. 16, if the controller 180 determines that the rear side 151B of the transparent display unit 151 currently faces toward the user by the process shown in FIG. 15, the controller 180 displays an information indicating that the side currently facing toward the user is the rear side 151B of the transparent display unit 151, thereby enabling the user to be aware that the side currently viewed by the user is the rear side 151B of the transparent display unit 151.

In particular, referring to FIG. 16 (a), based on the at least one state of the mobile terminal 100, if the controller 180 determines that the rear side 151B of the transparent display unit 151 currently faces toward the user, the controller 180 controls an information 310, which indicates that the side currently facing toward the user is the rear side 151B of the transparent display unit 151, to be displayed on the rear side 151B before reversing the content 212 displayed on the rear side 151B.

If the information 310 is selected, referring to FIG. 16 (b), the controller reverses the content 212 displayed on the rear side 151B to enable the user to view the content 212 in the correct direction through the rear side 151B. Without selecting the information 310, if determining that the rear side 151B of the transparent display unit 151 currently faces toward the user, the controller 180 can reversely display the content 212 as soon as the information is displayed.

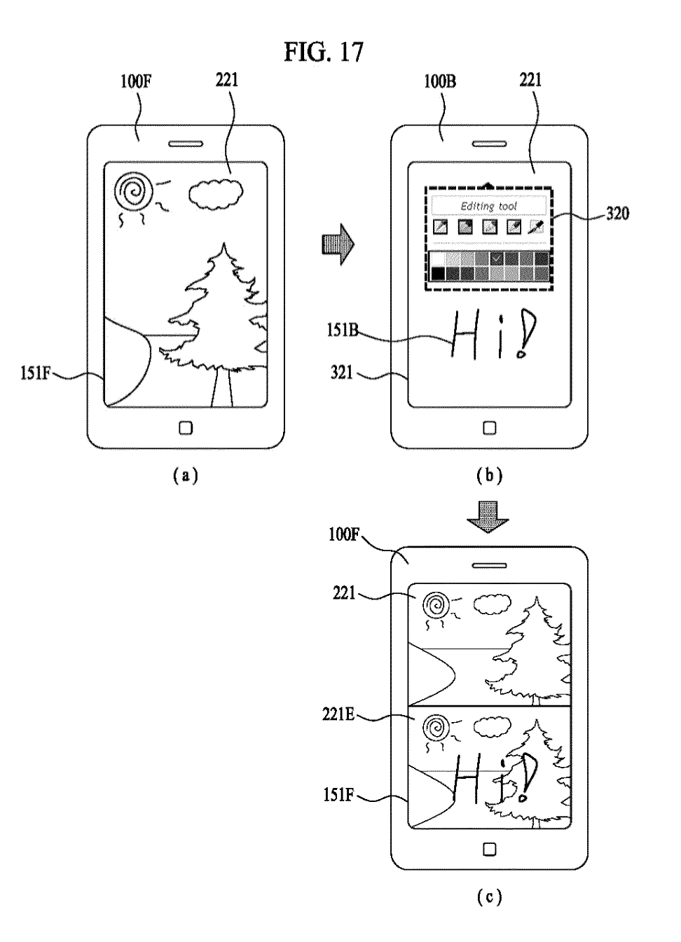

Referring to FIG. 17, based on the at least one state of the mobile terminal 100 according to the step S120, if the controller 180 determines that the rear side 151B of the transparent display unit 151 faces toward the user, the controller 180 can control an editing UI (user interface) 320 for editing a content 221, which is displayed on the front side 151F, to be displayed on the rear side 151B.

For instance, referring to FIG. 17 (a), before the mobile terminal 100 is turned over into the rear side 100B from the front side 100F by a user's grasp, the specific multimedia 221 is displayed on the front side 151F of the transparent display unit 151.

Based on the at least one state of the mobile terminal 100, if the controller 180 determines that the rear side 151B of the transparent display unit 151 faces toward the user, referring to FIG. 17 (b), the controller 180 controls an editing UI 320 for editing the multimedia 221 by at least one method to be displayed on the rear side 151B of the transparent display unit 151.

In this case, the editing UI 320 can include at least one of a memo function for inputting a memo content to the multimedia 221, a shift function for shifting the multimedia 221 to another storage region in the memory 160, a copy function for copying the multimedia 221 to another place, a rotate function for rotating an image of the multimedia 221 in at least one direction, a print function for printing the multimedia 221 through an external printer, a detail display function of displaying details of the multimedia 221, a delete function for deleting the multimedia 221, a share function for sharing the multimedia 221 by at least one method, and the like.

When the editing UI 320 is displayed on the rear side 151B of the transparent display unit 151, the controller 180 reversely displays the multimedia 221, which was previously displayed on the front side 151F, on the rear side 151B and is then able to display the editing UI 320.

Referring to FIG. 17 (b), if the multimedia 221 is edited by at least one method through the editing UI 320, the controller 180 can save the edited multimedia 221 in the memory 160 in response to user's manipulation. Referring to FIG. 17 (c), if the multimedia 221 is edited by at least one method through the editing UI 320, the controller 180 partitions a display region of the rear side 151B into at least two regions including a 1st region and a 2nd region, displays the multimedia 221 previous to the editing and the edited multimedia 221E on the 1st region and the 2nd region, respectively, and saved the edited multimedia 221E in the memory 160 in response to a user's manipulation.

For instance, referring to FIG. 17 (b) and FIG. 17 (c), if a desired memo content 321 is inputted onto the multimedia 221 through the editing UI 320 by a user, the controller 180 controls the multimedia 221 containing the memo content 321 to be saved in the memory or may control both of the multimedia 221 previous to the editing and the edited multimedia 221E to be displayed on the rear side 151B to enable the user to view the multimedia 221 previous to the editing and the edited multimedia 221E by comparing them to each other, in response to a user's manipulation.

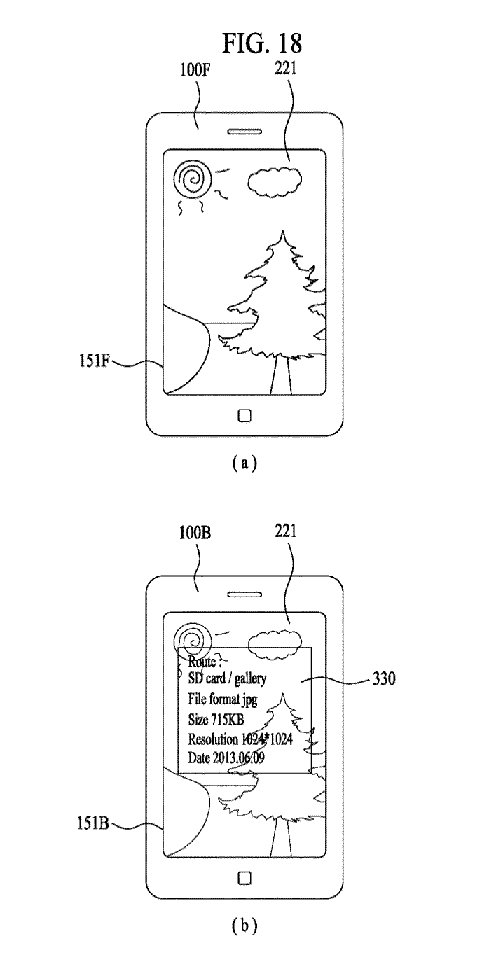

Referring to FIG. 18, based on the at least one state of the mobile terminal 100 according to the step S120, if the controller 180 determines that the rear side 151B of the transparent display unit 151 currently faces toward the user, the controller 180 can control a detail information 330 of a content 221, which is displayed on the front side 151F, to be displayed on the rear side 151B. For instance, referring to FIG. 18 (a), before the mobile terminal 100 is turned over into the rear side 100B from the front side 100F by a user's grasp, the specific multimedia 221 is displayed on the front side 151F of the transparent display unit 151.

Based on the at least one state of the mobile terminal 100, if the controller 180 determines that the rear side 151B of the transparent display unit 151 currently faces toward the user, referring to FIG. 18 (b), the controller 180 obtains the detailed information of the multimedia 221 previously displayed on the front side 151F and then controls the obtained detail information 330 of the multimedia 221 to be displayed on the rear side 151B of the transparent display unit 151. In doing so, the controller 180 controls the multimedia 221 displayed on the front side to be displayed on the rear side 151B by being reversed and then controls the detail information 330 of the multimedia 221 to be transparently displayed on the reversed multimedia 221.

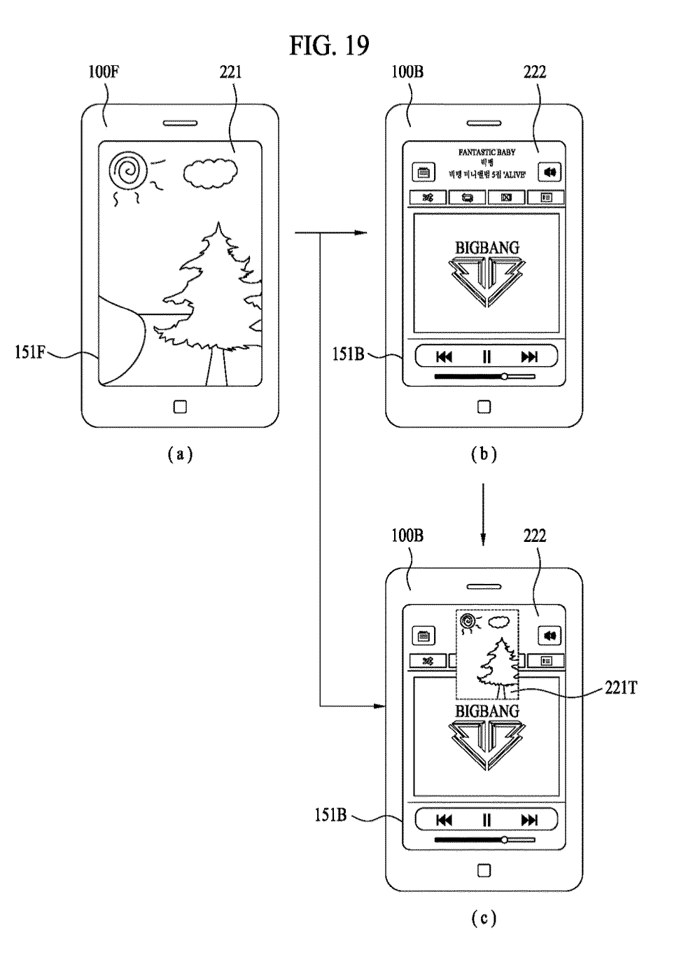

Referring to FIG. 19, based on the at least one state of the mobile terminal 100 according to the step S120, if the controller 180 determines that the rear side 151B of the transparent display unit 151 currently faces toward the user, the controller 180 can control a preset 2nd content 222, which is different from the 1st content 221 previously displayed on the front side 151F, to be activated and displayed on the rear side 151B.

For instance, referring to FIG. 19 (a), before the mobile terminal 100 is turned over into the rear side 100B from the front side 100F by a user's grasp, the specific 1st content 221 is displayed on the front side 151F of the transparent display unit 151. Based on the at least one state of the mobile terminal 100, if the controller 180 determines that the rear side 151B of the transparent display unit 151 currently faces toward the user, referring to FIG. 19 (b), the controller 180 controls the preset 2nd content 222 to be activated and displayed.

In doing so, the preset 2nd content 222 can be set by the user. In particular, when the rear side 151B of the transparent display unit 151 faces toward the user, the controller 180 displays a setting window for the settings of a content to be displayed on the rear side 151B in response to a user's request. If so, the user can set the 2nd content 222 to a desired content through the setting window.

On the other hand, referring to FIG. 19 (c), the controller 180 reverses the 1st content 221, which was displayed on the front side 151F, to be correctly viewed on the rear side 151B and is then able to control the reversed 1st content 221 to be displayed as a thumbnail 221T of a preview type to be displayed on the rear side 151B having an active screen of the 2nd content 222 displayed thereon.

In this case, the thumbnail 221T can be shifted on the rear side 151B by a user's touch & drag. A size of the thumbnail 221T can be enlarged or reduced by a user's manipulation. And, a transparency of the thumbnail 221T can be adjusted by a user's manipulation. Therefore, both of the 2nd content 222 set on the rear side 151B and the 1st content 221 previously displayed on the front side 151F can be viewed on the rear side 151B by the user.

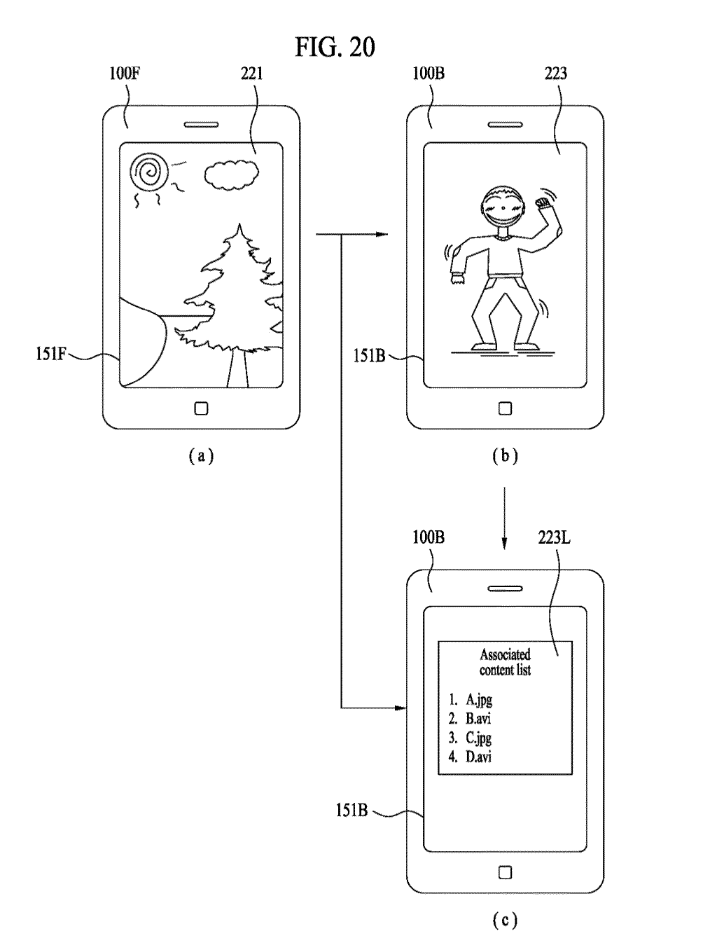

Referring to FIG. 20, based on the at least one state of the mobile terminal 100 according to the step S120, if the controller 180 determines that the rear side 151B of the transparent display unit 151 currently faces toward the user, the controller 180 can control at least one 2nd content 223, which is associated with the 1st content 221 previously displayed on the front side 151F, to be activated and displayed on the rear side 151B.

For instance, referring to FIG. 20 (a), before the mobile terminal 100 is turned over into the rear side 100B from the front side 100F by a user's grasp, the specific 1st content 221 is displayed on the front side 151F of the transparent display unit 151. Based on the at least one state of the mobile terminal 100, if the controller 180 determines that the rear side 151B of the transparent display unit 151 currently faces toward the user, the controller 180 obtains a category of the 1st content 221 and then searches contents saved in the memory 160 for the at least one 2nd content 223 having a category associated with the 1st content 221.

For instance, if the 1st content is a call function, the 2nd content having the category associated with the 1st content can become a phonebook. For another instance, if the 1st content is ‘Facebook’ that is one of SNS service applications, the 2nd content having the category associated with the 1st content can become ‘Twitter’. For another instance, if the 1st content is a video, the 2nd content having the category associated with the 1st content can become one of a photo, music, broadcast and game belonging to media.

In particular, referring to FIG. 20 (b), if one content associated with the 1st content 221 is found as the 2nd content 223 from the memory 160, the controller 180 activates and displays the found 2nd content 223 on the rear side 151B. In doing so, as mentioned in the foregoing description with reference to FIG. 19 (c), the controller 180 reverses the 1st content 221, which was displayed on the front side 151F, to be correctly viewed on the rear side 151B and is then able to control the reversed 1st content 221 to be displayed as a thumbnail of a preview type to be displayed on the rear side 151B having an active screen of the 2nd content 223 displayed thereon.

Moreover, referring to FIG. 20 (c), if at least two contents associated with the 1st content 221 are found as the 2nd content 223 from the memory 160, the controller 180 displays a list 223L including the found at least two contents on the rear side 151B by activating the 2nd content 223. If a specific content is selected from the list 223L, the controller 180 activates the selected content and then displays the activated content on the rear side 151B.

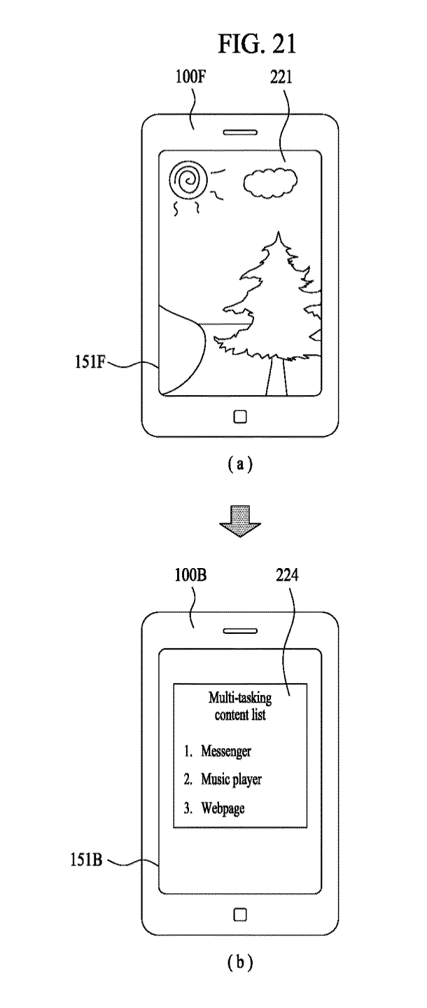

Referring to FIG. 21, based on the at least one state of the mobile terminal 100 according to the step S120, if the controller 180 determines that the rear side 151B of the transparent display unit 151 currently faces toward the user, the controller 180 can display a list of contents currently multitasked in the mobile terminal 100 on the rear side 151B.

For instance, referring to FIG. 21 (a), before the mobile terminal 100 is turned over into the rear side 100B from the front side 100F by a user's grasp, a specific 1st content 221 is displayed on the front side 151F of the transparent display unit 151. Based on the at least one state of the mobile terminal 100, if the controller 180 determines that the rear side 151B of the transparent display unit 151 currently faces toward the user, referring to FIG. 21 (b), the controller 180 controls a list 224 of the rest of the contents except the 1st content among the contents currently multitasked in the mobile terminal 100 to be displayed on the rear side 151B. Subsequently, if a specific content is selected from the list 224, the controller 180 activates the selected content and then displays the activated content on the rear side 151B.

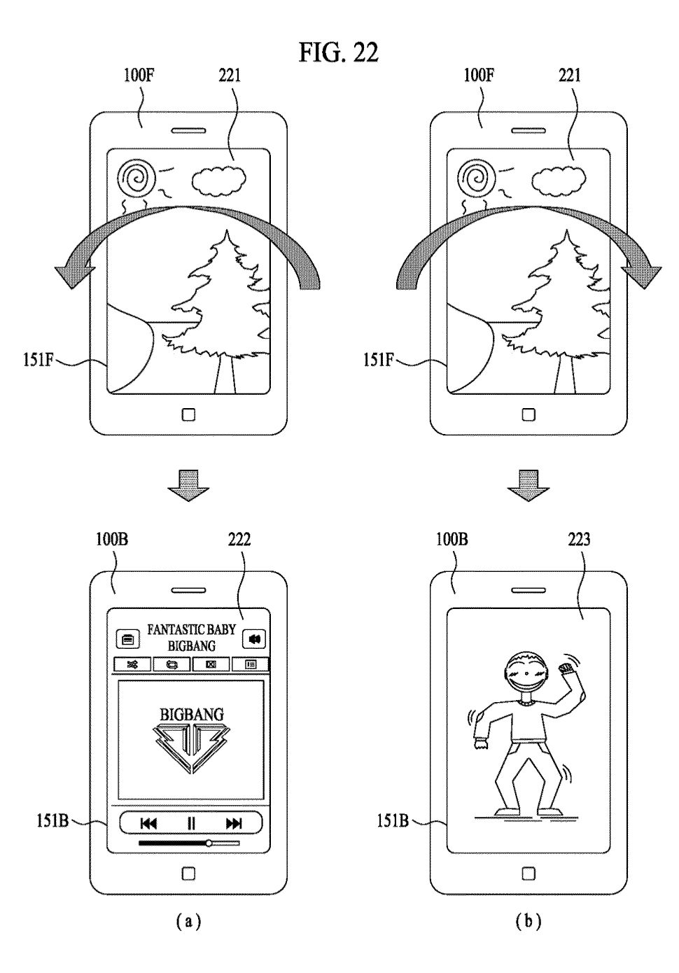

Referring to FIG. 22, if the controller 180 detects a 1st motion of turning over the transparent display unit 151 into the rear side 151B from the front side 151F in a 1st direction and a 2nd motion of turning over the transparent display unit 151 into the rear side 151B from the front side 151F in a 2nd direction opposite to the 1st direction through the motion sensor 142, the controller 180 can control currently multitasked different contents to be activated and displayed on the rear side 151B currently facing toward a user by the 1st motion and the 2nd motion.

For instance, referring to FIG. 22 (a), while the front side 151F of the transparent display unit 151 faces toward a user, if the 1st motion for turning over the mobile terminal 100 into the rear side 100B from the front side 100F in the 1st direction (e.g., a left direction) is detected through the motion sensor 142 as a motion of the mobile terminal 100 included in the at least one state of the mobile terminal 100, the controller 180 controls the 2nd content 222, which corresponds to one of the rest of the contents except the 1st content 221 previously displayed on the front side 151F among the currently multitasked contents, to be displayed on the rear side 151B.

For another instance, referring to FIG. 22 (b), while the front side 151F of the transparent display unit 151 faces toward a user, if the 2nd motion for turning over the mobile terminal 100 into the rear side 100B from the front side 100F in the 2nd direction (e.g., a right direction) is detected as a motion of the mobile terminal 100 included in the at least one state of the mobile terminal 100 through the motion sensor 142, the controller 180 controls a 3rd content 223 different from the 2nd content 222 according to the 1st motion, which corresponds to one of the rest of the contents except the 1st content 221 previously displayed on the front side 151F among the currently multitasked contents, to be displayed on the rear side 151B.

In this case, the 2nd content 222 may include the content activated right before the 1st content 221 previously displayed on the front side 151F among the currently multitasked contents. And, the 3rd content 223 may include the content activated right after the 1st content 221. The 2nd content 222 and the 3rd content may include the contents having the categories associated with the 1st content 221 among the currently multitasked contents. The 2nd content 222 may include the content most frequently used by the user among the currently multitasked contents. And, the 3rd content 223 may include the content least frequently used by the user among the currently multitasked contents.

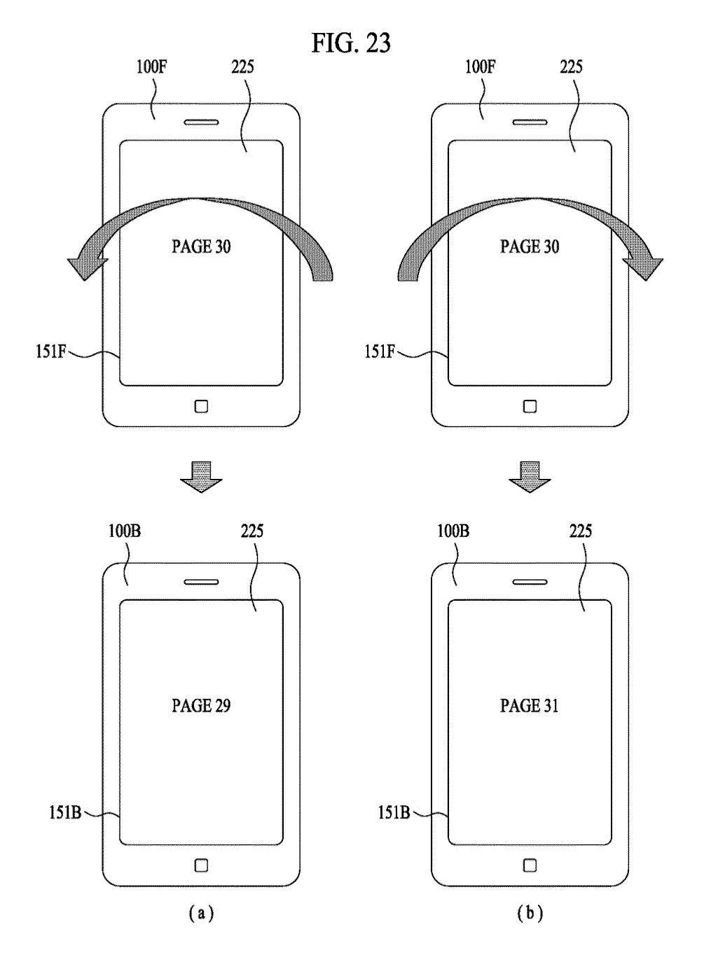

Referring to FIG. 23, if the controller 180 detects a 1st motion of turning over the transparent display unit 151 into the rear side 151B from the front side 151F in a 1st direction and a 2nd motion of turning over the transparent display unit 151 into the rear side 151B from the front side 151F in a 2nd direction opposite to the 1st direction through the motion sensor 142, the controller 180 can display different pages of a content 225 previously displayed on the front side 151F.

FIG. 23 shows that a specific page of a content 225 having at least two pages is displayed on the front side 151F of the transparent display unit 151. In this case, the content 225 having the at least two pages has at least two pages of a document, an e-book, a webpage, a home screen, a menu page, a phonebook, a memo and the like and can include all data of which pages can be switched on a screen.

Referring to FIG. 23 (a), while the front side 151F of the transparent display unit 151 faces toward a user, if the 1st motion for turning over the mobile terminal 100 into the rear side 100B from the front side 100F in the 1st direction (e.g., a left direction) is detected through the motion sensor 142 as a motion of the mobile terminal 100 included in the at least one state of the mobile terminal 100, the controller 180 controls a page (e.g., page 29), which is previous to the specific page (e.g., page 30) of the content 225 previously displayed on the front side 151F of the transparent display unit 151 before the 1st motion is inputted, to be displayed on the rear side 151B.

Referring to FIG. 23 (b), while the front side 151F of the transparent display unit 151 faces toward a user, if the 2nd motion for turning over the mobile terminal 100 into the rear side 100B from the front side 100F in the 2nd direction (e.g., a right direction) is detected as a motion of the mobile terminal 100 included in the at least one state of the mobile terminal 100 through the motion sensor 142, the controller 180 controls a page (e.g., page 31), which is next to the specific page (e.g., page 30) of the content 225 previously displayed on the front side 151F of the transparent display unit 151 before the 2nd motion is inputted, to be displayed on the rear side 151B.

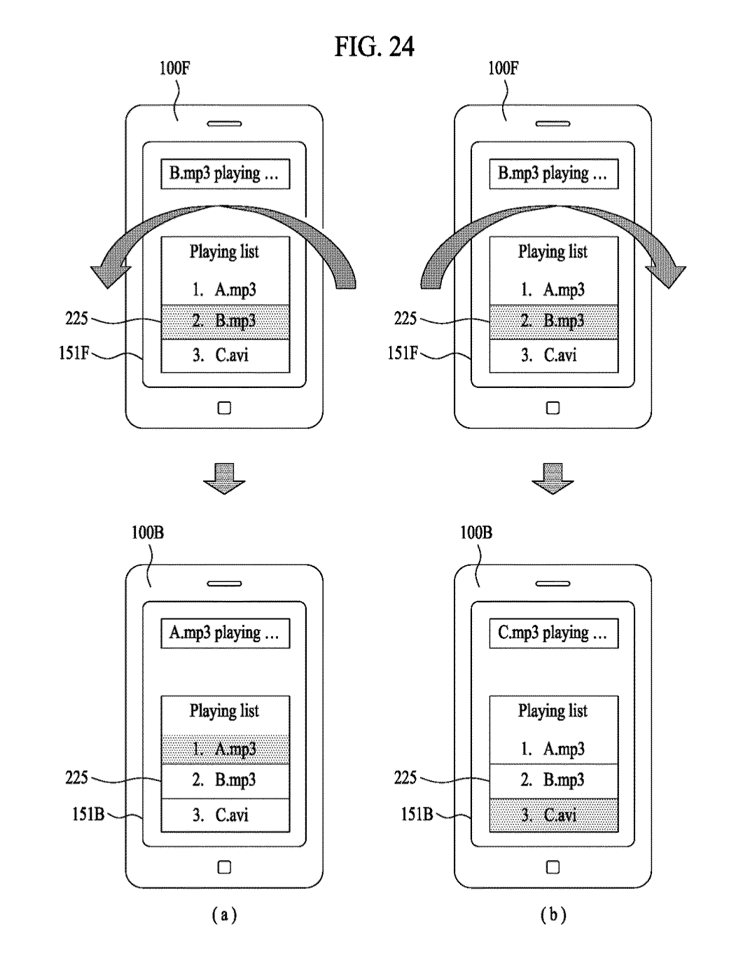

Finally, referring to FIG. 24, if the controller 180 detects a 1st motion of turning over the transparent display unit 151 into the rear side 151B from the front side 151F in a 1st direction and a 2nd motion of turning over the transparent display unit 151 into the rear side 151B from the front side 151F in a 2nd direction opposite to the 1st direction through the motion sensor 142, the controller 180 can play a media different from a media previously played on the front side 151F.

FIG. 24 shows that a media play list 225 is displayed on the front side 151F of the transparent display unit 151 and that a specific 1st media B.mp3 in the media play list 225 is currently played. Referring to FIG. 24 (a), while the front side 151F of the transparent display unit 151 faces toward a user, if the 1st motion for turning over the mobile terminal 100 into the rear side 100B from the front side 100F in the 1st direction (e.g., a left direction) is detected through the motion sensor 142 as a motion of the mobile terminal 100 included in the at least one state of the mobile terminal 100, the controller 180 plays a 2nd media A.mp3 having a play order previous to that of the 1st media B.mp3 in the media play list 225 and displays a play screen of the 2nd media A.mp3 on the rear side 151B.

Referring to FIG. 24 (b), while the front side 151F of the transparent display unit 151 faces toward a user, if the 2nd motion for turning over the mobile terminal 100 into the rear side 100B from the front side 100F in the 2nd direction (e.g., a right direction) is detected as a motion of the mobile terminal 100 included in the at least one state of the mobile terminal 100 through the motion sensor 142, the controller 180 plays a 3rd media C.mp3 having a play order next to that of the 1st media B.mp3 in the media play list 225 and displays a play screen of the 3rd media C.mp3 on the rear side 151B.

Accordingly, embodiments of the present disclosure provide various effects and/or features. First of all, the present disclosure determines which one of a front side and a rear side of a transparent display unit faces toward a user in consideration of a state of a user's grasp at the transparent display unit and then controls an information display of the transparent display unit depending on a result of the determination. Therefore, even if the user grasps a mobile terminal to enable any one of the front and rear sides of the transparent display unit to face toward the user, the present disclosure detects it automatically, thereby displaying a corresponding information in a correct form.

The above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal, comprising:
a transparent display having a first side and a second side opposite the first side, the transparent display configured to display information for each of the first side and the second side, one of the first and second sides corresponding to a front side of the mobile terminal; and
a controller configured to determine whether the first side or the second side is positioned to face a prescribed direction based on at least one state of the mobile terminal, and to control the information to be displayed on the transparent display according to a result of the determination.

2. The mobile terminal of claim 1, the transparent display includes
a first touch panel provided to the first side, and
a second touch panel provided to the second side,
wherein the at least one state includes at least one attribute of a contact sensed on at least one of the first touch panel or the second touch panel while the mobile terminal is being held by a user.

3. The mobile terminal of claim 2, wherein the at least one state includes a prescribed range for an electrostatic strength sensed on a touch panel, and when an electrostatic strength on the first touch panel is within the prescribed range, the controller determines that the second side is facing the user.

4. The mobile terminal of claim 2, wherein the at least one state includes a prescribed range for a size of an area touched on a touch panel, and when a size of an area of the contact sensed on the first touch panel is within the prescribed range, the controller determines that the second side is facing the user.

5. The mobile terminal of claim 2, wherein the at least one state includes a prescribed shape of an area touched on a touch panel, and when a shape of the contact sensed on the first touch panel corresponds to the prescribed shape, the controller determines that the second side is facing the user.

6. The mobile terminal of claim 2, wherein the at least one state includes a preset number of touches sensed on a touch panel, and when a number of touches sensed on the first touch panel is greater than or equal to the preset number of touches, the controller determines that the second side is facing the user.

7. The mobile terminal of claim 2, wherein the at least one state includes a prescribed region to which a touch will be inputted to a touch panel when held by the user, and when a recognized location of the contact sensed on the first touch panel corresponds to the prescribed region, the controller determines that the second side is facing the user.

8. The mobile terminal of claim 1, further comprising:
a proximity sensor provided to the first side of the transparent display, the proximity sensor configured to sense a proximity touch to the first side,
wherein the at least one state includes at least one attribute of the proximity touch sensed via the proximity sensor provided to the first side while the mobile terminal is being held by a user such that the second side is facing the user.

9. The mobile terminal of claim 8, wherein the at least one state includes a prescribed range for a proximity distance to the first side, and when a sensed proximity distance to the first side is within the prescribed range, the controller determines that the second side is facing the user and the first side is facing the user's hand.

10. The mobile terminal of claim 8, wherein the at least one state includes a prescribed region to which a touch will be inputted on the first side while the second side is facing the user, and when a recognized location of the proximity touch corresponds to the prescribed region, the controller determines that the second side is facing the user.

11. The mobile terminal of claim 1, further comprising:
an illumination sensor provided to the first side of the transparent display, the illumination sensor configured to sense an illumination in front of the first side,
wherein when a change in illumination is sensed via the illumination sensor at the first side of the transparent display, the controller determines that the second side is facing a user.

12. The mobile terminal of claim 1, further comprising:
a camera provided to at least one of the first side or the second side of the transparent display,
wherein the controller determines whether the first side or the second side is facing a user based on facial recognition using the camera.

13. The mobile terminal of claim 1, further comprising:
a motion sensor configured to sense an orientation of the mobile terminal relative to gravity,
wherein the at least one state includes the orientation of the mobile terminal relative to gravity and the controller determines that one of the first side or the second side that faces a direction opposite a sensed direction of gravity is facing the prescribed direction toward a user.

14. The mobile terminal of claim 1, further comprising:
a microphone provided to at least one of the first side or the second side of the transparent display,
wherein when a voice input is received via the microphone, the controller determines that one of the first side or the second side to which the microphone is provided is facing the prescribed direction toward a user.

15. The mobile terminal of claim 1, wherein, when the information is displayed on the transparent display for viewing from the first side and the controller determines that the second side is facing the prescribed direction toward a user, the controller reverses a display of the information on the transparent display to be viewed from the second side.

16. The mobile terminal of claim 1, wherein, when the controller determines that a rear side of the mobile terminal is facing the prescribed direction toward a user as the result of the determination, the controller displays information indicating that the side facing the user is the rear side.

17. The mobile terminal of claim 1, wherein, in a state in which a prescribed content is displayed on the first side, when the controller determines that the second side is facing the prescribed direction toward a user, the controller controls to display an editing UI (user interface) for editing the prescribed content on the second side.

18. The mobile terminal of claim 1, wherein, in a state in which a prescribed content is displayed on the first side, when the controller determines that the second side is facing the prescribed direction toward a user, the controller controls to display detail information for the prescribed content on the second side.

19. The mobile terminal of claim 1, wherein, in a state in which a first content is displayed on the first side, when the controller determines that the second side is facing the prescribed direction toward a user, the controller controls to display a second content different than the first content on the second side.

20. The mobile terminal of claim 19, wherein the controller reverses an orientation of the first content for viewing from the second side and displays the first content as a thumbnail on the second side.

21. The mobile terminal of claim 1, wherein, in a state in which a first content is displayed on the first side, when the controller determines that the second side is facing the prescribed direction toward a user, the controller controls to display a second content related to the first content on the second side.

22. The mobile terminal of claim 1, wherein, in a state in which a prescribed content is displayed on the first side, when the controller determines that the second side is facing the prescribed direction toward a user, the controller controls to display a list of currently multitasked contents on the second side.

23. The mobile terminal of claim 1, further comprising:
a motion sensor configured to detect a first motion of turning the mobile terminal over from the first side to the second side in a first direction and a second motion of turning over from the first side to the second side in a second direction,
wherein when the first motion is detected via the motion sensor, the controller displays a first content among currently multitasked contents on the second side, and
wherein when the second motion is detected via the motion sensor, the controller displays a second content among the currently multitasked contents on the second side.

24. The mobile terminal of claim 1, further comprising:
a motion sensor configured to detect a first motion of turning the mobile terminal over from the first side to the second side in a first direction and a second motion of turning over from the first side to the second side in a second direction,
wherein a prescribed page of a prescribed content including at least two pages is displayed on the first side, and
wherein when the first motion is detected via the motion sensor, the controller displays a previous page to the prescribed page on the second side, and when the second motion is detected via the motion sensor, the controller displays a next page to the prescribed page on the second side.

25. The mobile terminal of claim 1, further comprising:
a motion sensor configured to detect a first motion of turning the mobile terminal over from the first side to the second side in a first direction and a second motion of turning over from the first side to the second side in a second direction,
wherein a multimedia play list including at least two media content is displayed on the first side, and the controller scrolls up or down the playlist to play media content according to the detected first motion or second motion.

26. A method of controlling a mobile terminal including a transparent display having a first side and a second side, the transparent display configured to display information on each of the first side and the second side, the method comprising;
recognizing at least one state of the mobile terminal;
determining whether the first side or the second side is positioned to face a prescribed direction based on the recognized at least one state of the mobile terminal; and
controlling the information to be displayed on the transparent display according to a result of the determination.
